(19) United States
(12) Patent Application Publication
(10) Pub. No.: US 2025/0006399 A1
(43) Pub. Date: Jan. 2, 2025

(54) SYSTEM COMPRISING A POWER TOOL AND AN ENERGY SUPPLY DEVICE, AND ENERGY SUPPLY DEVICE

(71) Applicant: Hilti Aktiengesellschaft, Schaan (LI)

(72) Inventors: Markus HARTMANN, Mauerstetten (DE); Jens KONDRATIUK, Buchs (CH); Markus HOLUBARSCH, Landsberg am Lech (DE); Robert STANGER, Kaufbeuren (DE); Rene RICHTER, Augsburg (DE)

(21) Appl. No.: 18/707,749

(22) PCT Filed: Nov. 15, 2022
(86) PCT No.: PCT/EP2022/081905

§ 371 Date: May 6, 2024

(30) Foreign Application Priority Data
Dec. 1, 2021 (EP) 21211571.1

(51) Int. Cl. H01B 1/02; H01M 50/247

(52) U.S. Cl. CPC H01B 1/026; H01M 50/247; H01M 2220/30

(57) ABSTRACT

A system including a power tool and an energy supply device, wherein the energy supply device is provided for supplying the power tool with electrical energy. The energy supply device can be releasably connected to the power tool via an interface, wherein the interface comprises at least a female contact partner and a male contact partner. The interface has a total electrical transition resistance per pole of less than 0.4 milliohm, preferably less than 0.3 milliohm and particularly preferably less than 0.2 milliohm. At least one of the contact partners has a first coating, wherein the first coating has a graphite proportion of less than 30%. In addition, the interface may comprise more than six, preferably more than eight and most preferably more than twelve individual contact points. An energy supply device for use in the system is also provided.

The present invention relates to a system comprising a power tool and an energy supply device, wherein the energy supply device is provided for supplying the power tool with electrical energy. The energy supply device can be releasably connected to the power tool via an interface, wherein the interface comprises at least a female contact partner and a male contact partner. In a second aspect, the invention relates to an energy supply device for use in the system.

### BACKGROUND OF THE INVENTION

So-called cordless power tools, for example cordless screwdrivers, drills, saws, grinders or the like, may be connected to an energy supply device for power-supply purposes. The energy supply device may for example be configured as or comprise a rechargeable battery. Rechargeable batteries usually have a plurality of energy storage cells, also known as accumulator cells, by means of which electrical energy may be received, stored and released again. If the rechargeable battery is connected to a power tool, the electrical energy stored in the energy storage cells may be fed to the consumer (e.g. a brushless electric motor) of the power tool. For charging purposes, i.e. for loading the energy storage cells with electrical energy, the rechargeable battery is connected to a charging apparatus, such as a charger, so that electrical energy can enter the energy storage cells.

For example, DE 10 2015 110 308 A1 discloses a battery pack which has at least one contact, via which a circuit board can be connected to a busbar as an electrical solid body conductor.

US 2014 0087 246 A1 describes a battery which may for example be fixedly mounted in a vehicle.

DE 10 2016 120 329 A1 describes a connection device for an electrical device or energy accumulator.

US 2019 0259 985 A1 discloses a battery pack, an electrical device using a battery pack for energy supply, and an electrical device system. Various interfaces are for fixing batteries of different voltages to an electrical device.

CN 112 670 723 A describes a battery pack electrode plate and a battery pack. The battery pack comprises a battery pack electrode panel. Electrode films are used to enlarge the contact area between the battery pack and the electrical device to be supplied.

### SUMMARY OF THE INVENTION

Future battery technologies will be characterized by a long service life and high discharge currents. This means that the currents to be transmitted from the energy supply device to the power tool will be higher than before, and the service life of the energy supply device will also be extended in comparison with current energy supply devices. The interface between the power tool and the energy supply device constitutes a particular technical challenge. At the interface, the electrical contacts of the power tool and the electrical contacts of the energy supply device (“contact partners”) are connected to one another such that the electrical energy stored in the energy storage cells may be transferred from the rechargeable battery to the power tool.

In order to meet the increased chemical and/or electrical requirements of these future battery technologies, an object of the present invention is to provide a system of power tool and energy supply device, and an energy supply device, by means of which the power density of the interface can be improved and its service life extended. In particular, the industry would welcome an interface able to transmit higher currents than before from the energy supply device to the power tool, and an interface able to ensure optimum utilization of future battery technologies.

According to the invention, a system is provided comprising a power tool and an energy supply device for supplying the power tool with electrical energy, wherein the energy supply device can be releasably connected to the power tool via an interface, wherein the interface comprises at least a female contact partner and a male contact partner, wherein the interface has a total electrical transition resistance per pole of less than 0.4 milliohm, preferably less than 0.3 milliohm and particularly preferably less than 0.2 milliohm. At least one of the contact partners has a first coating, wherein the first coating has a graphite proportion of less than 30%. Because the total electrical transition resistance of the interface per pole has a value of less than 0.4 milliohm, preferably less than 0.3 milliohm and particularly preferably less than 0.2 milliohm, a system may be provided with which surprisingly high currents can be transmitted from the energy supply device to the power tool. These are preferably constant currents of the order of more than 50 ampere (A), preferably more than 70 A, most preferably more than 100 A. In this way, a powerful or high-powered energy supply device may be utilized to the optimum and its stored electrical energy transmitted optimally to the power tool. It has been found that the interface is particularly robust and durable so that it can tolerate the high electrical and mechanical loads which may be associated with future cell technologies, and allow optimum utilization of these future cell technologies. The reduction in total electrical transition resistance advantageously leads to an increased current-carrying capacity of the interface, so that the invention allows operation of or electrical energy supply to power tools in the higher power classes, i.e. particularly high-powered power tools. The reduction in power losses in the transition resistance may advantageously lead to a reduced thermal load of the surrounding components. In particular, components of thermoplastic material may thereby be effectively protected from damage owing to the effect of excessive heat.

The phrase that, in the context of the present invention, the “total electrical transition resistance per pole” is measured, preferably means in the sense of the invention that the total electrical transition resistance is measured in one of the two current directions of the system of the power tool and energy supply device. Preferably, a first current path exists between the positive pole of the energy supply device and the power tool, in particular a consumer inside the power tool, and a second current path between the power tool, in particular a consumer inside the power tool, and the negative pole of the energy supply device. This course of the current paths is illustrated for example in FIG. 18. In the context of the invention, it is preferred that the positive pole of the energy supply device is designated the cathode, while the negative pole of the energy supply device is designated the anode. Thus the first current path preferably exists between the cathode of the energy supply device and the consumer of the power tool, and the second current path between the consumer of the power tool and the anode of the energy supply device. In the exemplary embodiment shown in FIG. 18, for example, the total electrical transition resistance of the interface is measured in the first current path shown in the upper part of the figure. Preferably, the total electrical transition resistance is measured between the positive pole of the energy supply device and the power tool. Preferably, an ohmmeter is used to measure the total electrical transition resistance, and a measurement current supply device connected in parallel thereto. The ohmmeter preferably constitutes a measuring device for the electrical resistance, wherein it is preferably configured to also detect the particularly low total electrical transition resistances which occur in the context of the present invention. The ohmmeter is thus preferably also known as a resistance meter. The measurement current supply device may preferably comprise or be formed by a power source. The measurement current supply device is preferably configured to output a current, wherein in the context of the present invention, for example a current of 1 ampere is output by the measurement current supply device.

Preferably, the contact partners can be releasably connected together via a plug connection. In the sense of the invention, it is quite particularly preferred that the male and female contact partners of the interface can be connected together without tools. A simple connectability of the contact partners is particularly advantageous because the power tool and the energy supply device are connected together many times. Therefore the interface allows a particularly simple connection of the contact partners via a plug connection, which is durable and designed to be separated after each discharge of the energy supply device by use of the power tool and reconnected after the charging of the energy supply device. Thus the interface of the system differs from current transmission solutions known in the prior art, in which for example current or electrical energy is transmitted inside an energy supply device. In addition, the interface described in the context of the present invention differs from interfaces which are connected only once but permanently to a technical device or a vehicle. For example, during mounting or installation, energy supply devices may be permanently connected to a vehicle via screw connections, wherein such energy supply devices then remain in the vehicle for a long time. The invention deviates from such screw connections in that the contact partners of the interface can be connected together preferably without tools via a particularly durable and robust plug connection. Rather, it is part of the proper use of the power tool that the energy supply device is regularly exchanged for performance of work. In other words, on use of the power tool according to the operating instructions, the energy supply device is regularly exchanged, preferably when the energy of the energy supply device has been “consumed” and the energy supply device must be recharged, i.e. charged again, for example in a charger. In the sense of the invention, it is quite particularly preferred that the energy supply device can be detached without tools by the user of the power tool, which is not the case with energy supply devices installed in an electrical device or a vehicle during an installation process. Advantageously, the energy supply device may be removed from the power tool by the user without the need to carry a special tool. Such tool-less removal of the energy supply device is preferably repeated whenever the energy of the energy supply device has been “consumed” and the energy supply device must be exchanged or recharged. The preferably regular removal and insertion of the energy supply device from and into the power tool is preferably also known in the sense of the invention as the “removal or insertion cycle”.

It is preferred in the sense of the invention that the power tool and energy supply device are known as “connection partners of the interface”. Preferably, the connection partners of the interface each have at least one contact partner, wherein in the sense of the invention, it is particularly preferred that each connection partner of the interface has more than one contact partner. The contact partners may be configured as female or male contact partners, wherein in each case, one female and one male contact partner may form a respective current transmission pair. If for example each connection partner of the interface has two, preferably mutually corresponding, contact partners, then for example two current transmission pairs may be formed. The term “corresponding” in the sense of the invention means that a female contact partner corresponds to a male contact partner, because the one female and the one male contact partner are configured so that they together form a current transmission pair. For example, the contact partners may be configured as plug contacts which can be plugged together. In particular, a blade of the male contact partner may be inserted in a receiving clamp terminal of the female contact partner. Evidently, other connection methods are also preferred in the context of the present invention. In the sense of the invention, it is preferred that the contact partners of the connection partners of the interface are described as power contacts in order to distinguish them from communication contacts or elements. Whereas the power contacts are configured to transmit electrical energy, preferably from the energy supply device in the direction of the power tool, the communication contacts or elements may be configured to exchange data between the connection partners of the interface.

It is preferred in the sense of the invention that the power tool and energy supply device each comprise a group of contact partners. For example, the energy supply device may have a group or number of female contact partners, while the power tool has a group or number of male contact partners. Evidently, the arrangement of contact partners may also be reversed, i.e. the power tool may have a group of female contact partners while the energy supply device has a group of male contact partners. In the sense of the invention, it may also be preferred that the power tool and the energy supply device have “mixed” groups of contact partners, i.e. both female and male contact partners. If the power tool or the energy supply device has for example four contact partners, then for example two or three contact partners may be configured as male contact partners and the other contact partners as female contact partners.

It is preferred in the sense of the invention that the contact partners of the interface, i.e. the power tool and the energy supply device, have a corresponding number of contact partners. It is preferred in the sense of the invention that the power tool and energy supply device have a same number of contact partners. If for example the power tool has four male contact partners, it may be preferred in the sense of the invention that the energy supply device also has four contact partners, in this case preferably four female contact partners. In this exemplary embodiment of the invention, four current transmission pairs may be formed, via which electrical energy can be transmitted from the energy supply device to the power tool. In the sense of the invention, it may however be equally preferred for the number of contact partners of the power tool and the number of contact partners of the energy supply device to differ. In this exemplary embodiment of the invention, the power tool may for example have four male and the energy supply device two female contact partners. When the energy supply device is connected to the power tool, then preferably only two current transmission pairs are formed, via which electrical energy can be transmitted from the energy supply device to the power tool. Preferably, in this exemplary embodiment of the invention, two male contact partners of the power tool remain unused or empty since they are not allocated, and in this exemplary embodiment of the invention do not contribute to the transmission of electrical energy from the energy supply device to the power tool. In the sense of the invention, it may also be preferred that the power tool has two male and the energy supply device four female contact partners. In this exemplary embodiment of the invention, then when connected, two female contact partners of the energy supply device remain unused or unoccupied, so that in this exemplary embodiment of the invention they do not contribute to the transmission of electrical energy from the energy supply device to the power tool.

It is preferred in the sense of the invention that the interface comprises at least six, preferably at least eight and most preferably at least twelve individual contact points per pole. The inventors have found that the total electrical transition resistance of the interface of the system can be reduced in particular if a high number of individual contact points is provided between the female and male contact partners of the interface. In the sense of the invention, it is preferred that the number of individual contact points of the interface can be increased if the at least one female contact partner has more than one leg, wherein the legs of the female contact partner in the sense of the invention may preferably also be described as “contact arms”. In this exemplary embodiment of the invention, it is preferred that the at least one female contact partner of the interface has at least six, preferably at least eight, and most preferably at least twelve individual contact points per pole, for example if the female contact partner has multiple legs or contact arms.

In the sense of the invention, it may also be preferred that in each case one male contact partner and one female contact partner form a current transmission pair, wherein the at least one current transmission pair of the interface has at least six, preferably at least eight and most preferably at least twelve individual contact points per pole. In the sense of the invention, it may also be preferred that more than one contact partner or more than one power contact is provided on each connection partner of the interface. Then for example two, three, four, five or more current transmission pairs may be formed, each having one female and one male contact partner, wherein the higher number of current transmission pairs advantageously means that more electrical energy can be transmitted from the energy supply device to the power tool. In addition, the higher number of current transmission pairs may mean that higher current levels can be transmitted from the energy supply device to the power tool. These are preferably constant currents of the order of more than 50 ampere (A), preferably more than 70 A, most preferably more than 100 A.

The inventors have found that the current-bearing capacity can be further improved if at least one of the contact partners has a first coating, wherein a silver proportion of the first coating in percent by mass lies in a region of more than 70%, preferably in a region of more than 95%. The provision of the first coating may advantageously mean that the total electrical transition resistance of the interface of the system may be further reduced in comparison with interfaces with uncoated contact partners, so that the power capacity of the energy supply device may be even better utilized. Tests have shown that coatings with a silver portion in percent by mass in a region of more than 70%, preferably more than 95%, are particularly suitable for surprisingly greatly reducing the total electrical transition resistance of the interface and hence further improving the power density of the interface. For example, the first coating may comprise silver or silver graphite, without being restricted thereto.

It is preferred according to the invention that the first coating lies in the region of the individual contact points. The term “individual contact point” in the sense of the invention preferably means the points or regions of the contact partners which are in contact with a contact partner when connected in order to transmit electrical energy. The term preferably refers to the local points of touch between the contact partners, which may be pressed via an inherently sprung contact arm onto the counter-partner, for example the blade of the male contact partner. The contact points may be configured as points, lines or areas of touch. As evident for example on the figures, the female contact partners usually have two legs or contact arms which surround the blade of the male contact partner when connected. If the female contact partner has two legs or contact arms which each touch the male contact partner at precisely one point, the corresponding current transmission pair preferably has two individual contact points. If each of the two contact arms of the female contact partner is divided into two individual arms, and the individual arms each touch the male contact partner at precisely one point, the corresponding current transmission pair preferably has four individual contact points. In the context of the present invention, preferably the number of individual contact points is also given per pole. In the sense of the invention, this preferably means that the number of individual contact points arises from the number of contact partners per pole concerned and the number of individual contact points of these contact partners. For example, the number of individual contact points in the first current path may be determined by first establishing the number of contact partners or current transmission pairs which are connected to the positive pole, i.e. the cathode of the energy supply device. For example, the positive pole, i.e. the cathode of the energy supply device, may be connected to two contact partners, wherein the two contact partners may form two current transmission pairs. The female contact partners of the current transmission pairs which are connected to the positive pole of the energy supply device each have two contact arms, wherein these contact arms may for example each be divided into four individual contact arms. Then each individual current transmission pair has eight individual contact points (four on each contact arm, total eight) and the number of individual contact points per pole-here for the positive pole—in this exemplary embodiment of the invention amounts to sixteen, because there are two female contact partners connected to the positive pole of the energy supply device. In other words, the first current path which is considered in this example comprises sixteen individual contact points per pole. The term “when connected” preferably describes the state in which the energy supply device is connected to the power tool, so that the electrical energy or current can be transmitted from the energy supply device to the power tool. Preferably, the first coating is present at least in the region of the individual contact points of the contact partners. The first coating may also be present at other points of the contact partners.

In the sense of the invention, it is preferred that at least one of the contact partners has a second coating, wherein a nickel proportion of the second coating in percent by mass lies in the region of more than 83%. The second coating is preferably configured to improve an adhesion of the first coating to a base material of the contact partner. The second coating may thus advantageously be used for nickel subcoating of the contact partners. Preferably, the second coating is thus arranged between the base material and the first coating. The base material of the contact partner having the first and/or second coating may preferably be a highly conductive material such as e.g. copper. Preferably, the first and/or second coating may be applied to this base material, wherein preferably, firstly a second coating may be applied to the base material in order to lay the foundation for a good adhesion of the first coating to be applied subsequently. Tests have shown that coatings with a nickel proportion in percent by mass in a region of more than 83% are particularly suitable for improving the adhesion between the base material of the contact partner and the first coating or the first coating material, and lead to surprisingly good adhesion results. It is preferred within the sense of the invention that the second coating comprises nickel and/or nickel phosphorus.

In the sense of the invention, it is preferred that a total thickness of the first coating and the second coating lies in a region of more than 4 μm, preferably in a region of more than 8 μm and most preferably in a region of more than 10 μm. In the sense of the invention, this means preferably that a sum of the thickness of the first coating and the thickness of the second coating may be more than 4 μm, preferably more than 8 μm and most preferably more than 10 μm. Tests have shown that a total thickness of the first coating and the second coating in said regions is particularly suitable for further reducing the total electrical transition resistance of the interface and hence improving the power density of the interface.

According to the invention, it is provided that the first coating has a graphite proportion of less than 30%. It is preferred in the sense of the invention that a graphite proportion of the first coating lies in a region of less than 30%. Tests have shown that a graphite proportion of less than 30% of the first coating in said region is particularly durable and robust, and in addition is very suitable for obtaining the low total electrical transition resistance of the interface and hence the power density of the interface over a very long service life. The second coating preferably contains no graphite. The phrase that the “second coating contains no” in the sense of the invention preferably means that it is not provided by the manufacturer that graphite is contained in the second coating. However, because of diffusion and atomic migration processes, it cannot be excluded that foreign atoms such as graphite, i.e. carbon, or copper are deposited above all in the region of the boundary layers to the base material or the first coating.

In the sense of the invention, it is preferred that at least one of the contact partners has a microstructure on its surface, wherein the microstructure has a reduced peak height of more than 0.3 μm and/or a reduced groove depth of more than 0.3 μm. The reduced peak height may preferably be the mean height of such elements which protrude from the surface of the at least one contact partner. The reduced peak height may preferably be described by the so-called Rpk value. The reduced groove depth may preferably be the mean depth of grooves which extend, starting from a surface of the at least one contact partner, into the material of the contact partner. The reduced groove depth may preferably be described by the so-called Rvk value. Thus in the sense of the invention, it is preferred that the microstructure has an Rpk value of 0.3 μm and/or an Rvk value of more than 0.3 μm. Tests have shown that this combination of the two roughness values guarantees astonishingly low transition resistances and a high wear-resistance of the interface. The configuration of the grooves, which preferably form “valleys” in the sense of the invention, leads to very good embedding of the lubricant, and the configuration of the “peaks” leads to very high local surface pressures between the two contact partners, so with said roughness values a particularly good electrical contact can be achieved.

The surface of the contact partner may for example be the surface of the blade of the male contact partner. In the female contact partners, the insides of the contact arms or the insides of the legs form the surface of the contact partner, wherein these insides of the contact arms or legs of the female contact partner are those which come into contact with the male contact partner when connected, so that electrical energy can be transmitted from the energy supply device to the power tool. In the sense of the invention, it is preferred that the microstructure is periodically repeated on the surface of the at least one contact partner.

In the sense of the invention, it is preferred that at least one of the contact partners has a lubricant on its surface, wherein the lubricant has an oil proportion in percent by mass of more than 40%. This preferably means In the sense of the invention that a preferably grease-containing lubricant can be applied to at least one of the contact partners in order to make the interface more robust against oxidation and thus extend its service life, and in order to improve the current transmission capacity of the interface. The lubricant may advantageously prevent both the abrasive and adhesive wear on the two contact partners during connection. In this way a premature, undesired wear of the coatings is prevented so that the good transition resistance is retained even with the coatings. Even if the coatings undergo a degree of wear towards the end of their service life, the lubricant advantageously helps to suppress the air supply to corrosion-sensitive base materials and thus prevent harmful oxidation. In the sense of the invention, it is preferred if the lubricant has for example an oil proportion of up to 95%, and an additive proportion of 0 to 10%, a thickener proportion of 3 to 40% and a solid lubricant proportion of 0 to 20%. Preferably, the oil and the additives constitute liquid constituents of the lubricant, wherein these preferably make up or establish the “oil proportion” of the lubricant. Thickeners and lubricants are solids and constitute a solids proportion of the lubricant.

In the sense of the invention, it is preferred that the lubricant comprises at least one solid for thickening, wherein the solid is a metal soap which is preferably configured as a metal complex soap, and/or a polyurea.

In addition, the lubricant may contain at least one additive as wear protection and or at least one additive for deactivation of non-ferrous metals. The additives for wear protection in the sense of the invention may also be described as “wear protection additives”, while the additives for non-ferrous metal deactivation may preferably be designated as “non-ferrous metal deactivators”. The wear protection additives can advantageously increase the wear resistance of the interface. If non-ferrous metal deactivators are used, the undesired oxidation of non-ferrous metals of the base materials may be reduced or decreased.

The contact partners of the connection partners of the interface may be spring-mounted in the respective device, the power tool or energy supply device. In the sense of the invention, it may be preferred that both the male and female contact partners are spring-mounted, or both groups of contact partners. In the sense of the invention, it may also be preferred that both the contact partners of the power tool and the contact partners of the energy supply device are spring-mounted, or both groups of contact partners. Preferably, the individual contact partners may each be individually spring-mounted, wherein this situation the sense of the invention is preferably designated as “individual spring-mounting”. In the sense of the invention, it may also be preferred that the power tool and/or the energy supply device comprises receiver devices for receiving the respective contact partners, wherein then for example the receiving devices may be spring-mounted. In the sense of the invention, it is also preferred that the spring-mounting may take place in the region of the power tool and/or in the region of the energy supply device. The term “spring-mounting” in the sense of the invention preferably means that the spring-mounted object, for example an individual contact partner or a receiving device which is preferably configured to receive or combine more than one contact partner, comprises an elastic means for spring-mounting. This elastic means for spring-mounting may for example comprise an elastic element such as a spring. Details of the spring-mounting are described below. The elastic means for spring-mounting is preferably configured to act on the contact partner or the receiving device to be spring-mounted. Preferably, by means of the contact partners, a form-fit and/or interference-fit connection is formed between the power tool and the energy supply device. It is an essential advantage of the invention that particularly large electrical currents can be transmitted by means of the form-fit and/or interference-fit connection, and that surprisingly, the relative distances between the contact partners can be kept particularly short, if not quite reduced to a minimum. In this way, advantageously, the service life of the interface between the power tool and the energy supply device can be considerably extended. The female and male contact partners of the interface in the sense of the invention may also preferably be described as “power contacts” of the interface. By the provision of the at least one elastic means for spring-mounting, it is possible to easily compensate for vibrations and oscillations acting on the contact partners, which may result in a relative movement and even an actual breaking of the contact connection between the rechargeable battery and the power tool.

In the sense of the invention, it is preferred that the contact partner on which the elastic means for spring-mounting acts, is movably mounted. In other words, the contact partner with which the elastic means for reducing the relative movement is actively connected, may be movably mounted. In the sense of the invention, it is further preferred that the movably mounted contact partner and/or the movably mounted receiving device is spring-mounted. If more than one contact partner is provided per connection partner of the interface, or if the power tool and/or the energy supply device has more than one receiving device, it may be preferred in the sense of the invention that the movably mounted contact partners and/or the movably mounted receiving devices are spring-mounted. In this way, the relative movements between the contact partners, and the transition resistance, may be further considerably reduced and the service life of the interface considerably extended.

The receiving device may form a contact block or contact means block which can be movably mounted or spring-mounted by means of the elastic means. It is preferred in the sense of the invention that the receiving device comprises the contact partners of a connection partner of the interface, i.e. the power tool or energy supply device. However, in the sense of the invention, it may also be preferred if several receiving devices are provided which may each receive a sub-quantity of the contact partners of a connection partner. Preferably, these several receiving devices may also be spring-mounted in that the elastic means for spring-mounting acts on these several receiving devices. Thus the receiving devices may comprise the power contacts, i.e. the female and male contact partners, and/or the communication elements. In the context of the invention, it is preferred that elastic means for reducing the relative movement are also described as “elastic means for reducing the relative movement between the contact partners” or as “elastic means”.

Preferably, the contact partner, on which the elastic means for reducing relative movement acts, is mounted so as to be movable relative to the power tool or relative to the energy supply device in the connected state. If the spring-mounting is provided on the power tool side, i.e. the at least one elastic means acts on the contact partner or receiving device of the power tool, the resulting spring-mounting in the region of the power tool preferably contributes to mounting the corresponding contact partner so as to be movable relative to the power tool in the connected state. If the spring-mounting is provided on the energy supply device side, i.e. the at least one elastic means acts on the contact partner or receiving device of the energy supply device, the resulting spring-mounting in the region of the energy supply device preferably contributes to mounting the corresponding contact partner so as to be movable relative to the energy supply device in the connected state.

In the context of the invention, it is preferred that the at least one male contact partner is arranged on the power tool. The male contact partners may comprise blades which may be inserted in a female contact partner of the interface or other system component. According to an advantageous embodiment of the present invention, it may be provided that the male contact partners are configured as pin-like plug connectors or blades, and the female contact partners of the interface as clamp terminals with elastically deformable legs for receiving the pin-like plug connectors or blades. The male contact partner may be formed by a protruding region and a stop, wherein the protruding region is inserted in one of the female contact partners in a connected state of the interface in which the energy supply device is connected to the power tool (“when connected”). In unconnected state, the power tool and the energy supply device may be independent and separate from one another. This may be the case for example if the energy supply device is being charged and is arranged in a charger. In the context of the invention, it may also be preferred that the at least one male contact partner is arranged on the energy supply device.

The energy supply device may preferably comprise at least one rechargeable battery (accumulator), wherein the energy supply device is configured to supply the power tool with electrical energy. Electrical energy is output from the energy supply device to the power tool in particular in the connected state in which the power tool is connected to the energy supply device by the interface. The female and male contact partners engage in one another when connected, so that electrical current or energy can flow between the contact partners via a contact region.

The at least one elastic means for spring-mounting may preferably comprise at least one elastic element such as a spring. Here, the elastic element may be configured in the form of a spring, and in particular as a spiral, bending or coil spring. Alternatively, the elastic element may be configured as a component of an elastically deformable material. An elastomer is also a possible material in this case. It is thus possible to easily counteract a vibration-related movement of the connection element in multiple directions, i.e. not only in the direction towards or away from the connection element. In addition, the undesired relative movements between the contact partners of the interface may be effectively shortened by the use of an elastic element.

In the sense of the invention, it is preferred that on insertion into the female contact partner, the male contact partner compresses the least one elastic means so that the elastic means is brought into a stressed state. This compressing may preferably constitute an elastic deformation or compression. Preferably, the terms “compression” and “elastic deformation”, and the corresponding verbs, are used synonymously in the context of the present invention. Compression of the elastic means advantageously leads to the stressed state. Alternatively or additionally, the at least one male contact partner may also be spring-mounted. The term “spring-mounting” in the sense of the invention means that the spring-mounted contact partner is actively connected to the elastic means between the contact partners. In other words, the elastic means between the contact partners may act on one of the contact partners, whereby advantageously a spring-mounting of the corresponding contact partner is achieved. In the sense of the invention, it is preferred that in the connected or locked state, in which the energy supply device and the power tool are connected together, the at least one elastic means is in a stressed or tensioned state. In the sense of the invention, it is preferred that the elastic means is prestressed even in the unfitted state, wherein a force flow within the energy supply device is closed. The at least one female contact partner may thereby rest on the energy supply device. By stressing the at least one elastic means, in particular with the contact system in connected state, the male and female contact partners are firmly pressed against one another so that a particularly good contact is formed between the contact partners. Because of this “sprung” contacting of the contact partners, or because of the particularly close contact of the contact partners, the power density of the resulting contact can be considerably increased, so it is possible to transmit constant electrical currents in a region of more than 50 amperes, preferably more than 70 amperes, or particularly preferably more than 100 amperes. Also, the service life of the contact system can be substantially extended so the contact system is particularly suitable for energy supply devices with long service lives and/or high output currents, because the higher mechanical and/or electrical requirements on an interface can be optimally fulfilled by the invention.

In the sense of the invention, it is preferred that when the energy supply device is connected to the power tool, the energy supply device is introduced for example into a cavity of the power tool. In order to create the electrical connection between the connection partners of “energy supply device” and “power tool”, in a first step the contact partners are brought into contact with one another. This preferably takes place in that the blades of the male contact partners are introduced into the receiving terminals of the female partners. This process is preferably also referred to in the sense of the invention as “bringing the contact partners together”. In particular, it is preferred in the sense of the invention that the movably mounted contact partner(s) is/are pressed onto the stationary contact partner(s), wherein the play or freedom of movement is advantageously provided by the invention in the region of the movably mounted contact partner. Then in a second step, the at least one elastic means is stressed, e.g. in that the elastic element is compressed or elastically deformed. Then additional mechanical fixing or locking mechanisms may engage, for example the locking elements may engage or come to rest in recesses, depressions or undercuts provided for this purpose. In the sense of the invention, it is particularly preferred that the stress of the elastic element is present in the locked state. In other words, in particular the elastic element is compressed when the energy supply device is connected to the power tool. The advantageous play and freedom of movement of the spring-mounted contact partners or receiving devices are preferably also present in the connected state. In the sense of the invention, it is preferred that the locking of the energy supply device to the power tool takes place in a force flow of the interface.

Thus in the context of the present invention, a method is disclosed for connecting an energy supply device to a power tool, wherein the method is characterized by the following method step:
a) bringing together the contact partners of the energy supply device and power tool,
b) stressing the at least one elastic means for spring-mounting,
c) engaging any locking elements to fix the energy supply device stably in the power tool.

In the context of the invention, it is preferred that the at least one female contact partner is arranged on the energy supply device. The at least one female contact partner may preferably be formed by a receiving terminal which is configured to receive the blade of the male contact partner. For this, the female contact partner may have two legs of an elastic material, wherein the legs are pushed apart on insertion of the male contact partner so that the male contact partner comes to lie in an interior of the female contact partner or receiving terminal. This case, in the sense of the invention, is referred to as the connected or plugged state of the interface. Because of the elasticity of the material from which the legs of the female contact partner are formed, the legs of the receiving terminal of the female contact partner in this connected state press on the blade or protruding region of the male contact partner, so that a contact region is created between the contact partners. Preferably, electrical current or energy is exchanged between the contact partners via this contact region, so that current or electrical energy can flow from the energy supply device towards the power tool. In the context of the invention, it may also be preferred that the at least one female contact partner is arranged on the power tool.

The legs of the female contact partner may preferably be formed from a good conductor, such as copper, in the contact regions to the male contact partner. The female contact partners may in addition comprise over-springs of spring steel, wherein the over-springs are preferably configured to press the legs of the female contact partners together so that when connected, a stable contact exists between the female and male contact partners. As well as spring steel, other metals or metal alloys with elastic properties may be used to produce the female contact partners. For the contact regions used to transmit electrical energy, materials with good conductivity, a high yield strength and/or low relaxation are particularly preferred, such as for example CuFe2P or CuCrSiTi. The contact regions may preferably be situated on the insides of the legs of the female contact partners, where they come into contact with the blades of the male contact partners when connected.

Tests have shown that by providing the elastic means for spring-mounting at the interface, friction corrosion (fretting) between the contact partners of the interface can be substantially reduced. In this way for example, either lower quality, cheaper coatings of the contact partners may be used, or the use of the at least one elastic means for reducing the relative movement leads to a longer service life of the interface and a higher power density, wherein the higher power density in the sense of the invention preferably means that higher electrical currents can be transmitted through the interface of male and female contact partners.

The invention cannot prevent an undesired movement or oscillation of the energy supply device, but the at least one elastic means for reducing the relative movement advantageously ensures that the pairs of male and female contact partners of the energy supply device and/or power tool, which are susceptible to contact and vibration, are decoupled and thus protected from their movements and vibrations.

In the sense of the invention, it is preferred that at least one male and one female contact partner in each case form a unit, wherein in a connected state, this unit is decoupled from a movement of the energy supply device and/or power tool. Advantageously, this decoupling of the unit of male and female contact partners and the energy supply device is in particular achieved by the at least one elastic spring-mounting means which acts on one of the contact partners or on the unit of at least one male and female contact partner. In other words, in the sense of the invention, it is preferred that the elastic means is configured to act on one of the contact partners or on the unit of a male and a female contact partner. The decoupling of the unit from the energy supply device arises in particular if the at least one elastic means is present on the energy supply device. In the context of the invention, it may also be preferred that the at least one elastic means is arranged on the power tool. In this case, the unit of male and female contact partners may preferably be decoupled from the power tool.

It is also preferred in the sense of the invention if the interface comprises a receiving device for receiving at least one female contact partner and/or at least one male contact partner. In other words, the receiving device may be configured to receive at least one female contact partner or at least one male contact partner, or at least one female and at least one male contact partner. In a preferred exemplary embodiment of the invention, the receiving device may receive at least one female contact partner. In the sense of the invention, it may be preferred that the female contact partners are arranged individually on the interface, or that they are part of a receiving device, wherein the individual female contact partners or the receiving device may be components of either the power tool or the energy supply device. It is most preferred in the sense of the invention that the individual female contact partners or the receiving device are part of the energy supply device.

In the sense of the invention, it is preferred that the energy supply device has an even number of contact partners, wherein the contact partners may be female and/or male contact partners. The energy supply device preferably has a positive pole and a negative pole, wherein each of the two poles is connected to a contact partner, i.e. has a contact partner. For example, the energy supply device may have two, four, six, eight or more contact partners which may be spring-mounted individually or in a contact block. Preferably, half of the contact partners may be assigned to the negative pole of the energy supply device, while the other half of the contact partners may be assigned to the positive pole of the energy supply device.

In the sense of the invention, it is preferred that the contact partners of the interface are individually spring-mounted, or that a contact block formed by the contact partners is spring-mounted as a whole. If the contact partners are individually spring-mounted, the contact partners may be individually actively connected to the elastic spring-mounting means. If the interface comprises for example four contact partners at one of the system elements, i.e. power tool or energy supply device, an elastic means or elastic element may be assigned to each of these four contact partners. Preferably, in this embodiment of the invention, this is referred to as “individual spring-mounting of the power contacts of the interface”. Alternatively, in the sense of the invention, it may be preferred that an entire contact block, which preferably comprises several contact partners—female and/or male—is spring-mounted as a whole. Such a contact block in the sense of the invention is also described as a contact means block, wherein the contact means block may be formed by a receiving device with power contacts. It is preferred in the sense of the invention that the contact block or receiving device is actively connected to an elastic means or elastic element. This means preferably, in the sense of the invention, that an elastic means or elastic element is assigned to the contact block or receiving device. Preferably, in this embodiment of the invention, this is referred to as a “spring-mounted receiving device” or a “spring-mounted contact means block”.

It is preferred within the meaning of the invention that the at least one elastic spring-mounting means is assigned to the receiving device, preferably as a whole. In this case for example, a receiving device, which may e.g. receive four female contact partners, may be connected to an elastic element with a corresponding system component, being the power tool or the energy supply device. The decoupling then takes place for example between the energy supply device and the receiving device, so that the female contact partners in the receiving device are decoupled or protected from movements and/or vibrations of the energy supply device and/or the power tool. Tests have shown that the use of a receiving device offers particularly good protection against tilt movements, and the friction moment between the contacts is considerably increased. The receiving device with the power contacts may preferably form a contact block, wherein the invention protects this preferably movably mounted or spring-mounted contact block particularly well against tilt movements or similar. This advantage of the invention may be achieved in that the support faces and friction forces of the individual terminal contacts of the female contact partners are spaced far apart from one another laterally or substantially perpendicularly to the insertion direction, and hence, because of the large lever arm of the mounting, are very well able to absorb dynamic tilt moments. The same applies to the support faces of a contact block if the female contact partners are received by a receiving device. The statements above apply similarly also to male contact partners, in particular if they are received by a receiving device and form a contact block.

Alternatively, it may be preferred that the at least one elastic spring-mounting means is assigned to a respective contact pair of female and male contact partners. In this case for example, each contact pair of female and male contact partners may have its own elastic means for reducing the relative movement, such as an elastic element, and be decoupled or protected from the movements and/or vibrations of the energy supply device and/or power tool by means of the elastic means.

In the context of the invention, an interface is also disclosed for transmission of electrical energy between a power tool and an energy supply device. The terms, definitions and technical advantages presented for the system of power tool and energy supply device preferably apply accordingly to the interface, the energy supply device described further below, and the method for connecting an energy supply device to a power tool by means of an interface. The interface is characterized in that the interface has a total electrical transition resistance per pole of less than 0.4 milliohm, preferably less than 0.3 milliohm and particularly preferably less than 0.2 milliohm.

In addition, the invention concerns a method for connecting an energy supply device to a power tool by means of an interface, which is characterized in that the interface has at least one male contact partner and at least one female contact partner, wherein the male contact partners and the female contact partners may be supported by at least one elastic spring-mounting means during creation of a contact for the purpose of transmission of electrical energy from the energy supply device to the power tool. In the sense of the invention, it is preferred that a male and a female contact partner in each case form a current transmission pair, i.e. a unit, wherein in a connected state, this unit is decoupled from a movement of the energy supply device.

In a second aspect, the invention relates to an energy supply device for use in the system. The energy supply device is preferably an energy supply device with a particularly long service life, and/or an energy supply device which is configured to provide particularly high currents, in particular constant currents of more than 50 amperes, preferably more than 70 amperes, and most preferably more than 100 amperes.

The energy supply device may preferably be an accumulator or a preferably rechargeable battery. Evidently, in the sense of the invention, it is also possible that the energy supply device comprises two or more accumulators and/or batteries. The accumulators and/or batteries may have so-called battery packs which for example comprise cylindrical cells. These cylindrical cells may for example contain a chemical substance comprising lithium ions, magnesium ions and/or sodium ions, without being restricted thereto. However, other cell types, for example with cuboid or cubic cells, may be used in the context of the present invention.

The energy supply device is preferably an energy supply device with a particularly long service life, and/or an energy supply device which is configured to provide particularly high currents, in particular constant currents of more than 50 amperes, preferably more than 70 amperes, and most preferably more than 100 amperes. The particularly long service life may preferably lead to the energy supply device surviving particularly many insertion processes or insertion cycles without showing signs of wear. In addition, the particularly long service life may mean that the chemical constituents of the energy supply device are configured to be recharged more often than former energy supply devices, without substantially ageing. An essential advantage of the system is that because of the low total electrical transition resistance, the high power capacity of the energy supply device can be particularly well utilized, so that a particularly large quantity of energy can be transmitted from the energy supply device to the power tool, and so that particularly high constant currents can flow from the energy supply device towards the power tool. In this way, the advantages of new cell and battery technologies may be optimally utilized by means of the invention. Also, the invention may provide a system of power tool and energy supply device which allows an efficient use of energy supply devices in battery-powered tools, in particular also for applications and uses which impose very high electrical power requirements and/or very high service life requirements on the system or its interface.

It is preferred in the sense of the invention that the energy supply device comprises at least one energy storage cell, wherein the at least one energy storage cell in the sense of the invention is preferably also designated a “cell” and has an internal resistance DCR_I of less than 10 milliohm (mOhm). In preferred refinements of the invention, the internal resistance DCR_I of the at least one cell may be less than 8 milliohms and preferably less than 6 milliohms. Here, the internal resistance DCR_I is preferably measured in accordance with standard IEC61960. The internal resistance DCR_I represents, in particular, the resistance of a cell of the energy supply device, wherein components or accessories of the cell make no contribution to the internal resistance DCR_I. A low internal resistance DCR_I is advantageous since in this way absolutely no undesired heat, which has to be dissipated, is produced. The internal resistance DCR_I is, in particular, a DC resistance which can be measured in the interior of a cell of the energy supply device. The internal resistance DCR_I can of course also assume intermediate values such as 6.02 milliohms; 7.49 milliohms; 8.33 milliohms; 8.65 milliohms or 9.5 milliohms.

It has been found that, with the internal resistance DCR_I of the at least one cell of less than 10 milliohms, an energy supply device can be provided which has particularly good thermal properties, in the sense that it can be operated particularly well at low temperatures, wherein the cooling cost can be kept surprisingly low. In particular, an energy storage device with a cell internal resistance DCR-I of less than 10 milliohm is particularly suitable for supplying electrical energy to particularly powerful power tools. Such energy supply devices can therefore make a valuable contribution to allowing the use of rechargeable battery-operated power tools even in areas of application which were previously assumed in the art to be inaccessible to rechargeable battery-operated power tools.

Advantageously, such an energy supply device can create a possibility of supplying a battery- or accumulator-powered tool having an energy supply device according to the invention with a high output power over a long period of time, without damaging the surrounding plastic components or the cell chemistry within the cells of the energy supply device.

It is preferred in the context of the invention for a ratio of a resistance of the at least one cell to a surface area A of the at least one cell to be less than 0.2 milliohm/cm², preferably less than 0.1 milliohm/cm² and most preferably less than 0.05 milliohm/cm². In the case of a cylindrical cell, the surface of the cell may be formed, for example, by the outer surface of the cylinder as well as the top side and the bottom side of the cell. Furthermore, it may be preferred in the context of the invention for a ratio of a resistance of the at least one cell to a volume V of the at least one cell to be less than 0.4 milliohm/cm³, preferably less than 0.3 milliohm/cm³ and most preferably less than 0.2 milliohm/cm³. For conventional geometric shapes, such as cuboids, cubes, spheres or the like, a person skilled in the art knows the formulae for calculating the surface or the volume of such a geometric body. In the context of the invention, the term “resistance” preferably denotes the internal resistance DCR_I which can preferably be measured in accordance with standard IEC61960. Preferably, this is a direct current resistance.

It is preferred in the context of the invention for the at least one cell to have a heating coefficient of less than 1.0 W/(Ah·A), preferably less than 0.75 W/(Ah·A) and particularly preferably of less than 0.5 W/(Ah·A). Furthermore, the at least one cell may be designed to output a current of greater than 1000 amps/liter substantially constantly. The discharge current is indicated in relation to the volume of the at least one cell, wherein the space measurement unit “liter” (l) is used as the unit for the volume. The cells according to the invention are therefore able to output a discharge current of substantially constantly greater than 1000 A per litre of cell volume. In other words, a cell with a volume of 1 liter is able to output a substantially constant discharge current of greater than 1000 A, wherein the at least one cell furthermore has a heating coefficient of less than 1.0 W/(Ah·A). In preferred embodiments of the invention, the at least one cell of the energy supply device may have a heating coefficient of less than 0.75 W/(Ah·A), preferably less than 0.5 W/(Ah·A). The unit for the heating coefficient is watts/(ampere hours·amperes). The heating coefficient may of course also have intermediate values, such as 0.56 W/(Ah·A); 0.723 W/(Ah·A) or 0.925 W/(Ah·A).

The invention advantageously allows the provision of an energy supply device having at least one cell which exhibits reduced heating and therefore is particularly well suited to supplying power tools in which high power levels and high currents, preferably constant currents, are desired for operation. In particular, the invention can be used to provide an energy supply device for a power tool in which the heat which is optionally created during operation of the power tool and, when outputting electrical energy to the power tool, can be dissipated in a particularly simple and uncomplicated manner. Tests have shown that the invention can not only be used to more effectively dissipate existing heat. Rather, the invention prevents heat being generated or the quantity of heat generated during operation of the power tool can be considerably reduced using the invention. The invention can advantageously be used to provide an energy supply device which can supply electrical energy in an optimum manner primarily also to power tools which have stringent requirements in respect of power and discharge current. In other words, the invention can provide an energy supply device for particularly powerful power tools with which heavy drilling or demolition work can be performed on construction sites for example.

The term “power tool” in the sense of the invention means a typical device which may be used on a construction site, for example a building site and/or an excavation site. They may be hammer drills, chisel cutters, core drills, angle grinders or abrasive cutters, power cutters or similar, without being restricted thereto. In addition, “power tools” in the sense of the invention may be auxiliary devices as used occasionally on construction sites, such as lamps, radios, vacuum cleaners, measuring devices, construction robots, wheelbarrows, transport devices, feeder devices or other auxiliary devices. The power tool may in particular be a mobile power tool, wherein the energy supply device may be used in particular also in stationary power tools, such as frame-mounted drills or circular saws. However, portable power tools are preferred, which in particular are powered by a battery or accumulator. The power tool may for example also be a charger for the energy supply device.

It is preferred in the context of the invention for the at least one cell to have a temperature cooling half-life of less than 12 minutes, preferably less than 10 minutes, particularly preferably less than 8 minutes. In the context of the invention, this preferably means that, with free convection, a temperature of the at least one cell is halved in less than 12, 10 or 8 minutes. The temperature cooling half-life is preferably determined in an inoperative state of the energy supply device, that is to say when the energy supply device is not in operation, that is to say is connected to a power tool. Energy supply devices with temperature cooling half-lives of less than 8 mins have primarily been found to be particularly suitable for use in powerful power tools. The temperature cooling half-life can of course also have a value of 8.5 minutes, 9 minutes 20 seconds or of 11 minutes 47 seconds.

Owing to the surprisingly low temperature cooling half-life of the energy supply device, the heat generated during operation of the power tool or when it is charging remains within the at least one cell only for a short time. In this way, the cell can be recharged particularly quickly and is rapidly available for re-use in the power tool. Moreover, the thermal loading on the components of the energy supply device or the power tool having the energy supply device can be considerably reduced. As a result, the energy supply device can be preserved and its service life extended.

It is preferred in the context of the invention for the at least one cell to be arranged in a battery pack of the energy supply device. A series of individual cells can preferably be combined in the battery pack and in this way inserted into the energy supply device in an optimum manner. For example, 5, 6 or 10 cells may form a battery pack, with integral multiples of these numbers also being possible. For example, the energy supply device can have individual cell rows which may comprise, for example, 5, 6 or 10 cells. An energy supply device having, for example, three rows of five cells may comprise, for example, 15 individual cells.

In the sense of the invention, it is preferred that the energy supply device has a capacity of at least 2.2 Ah, preferably at least 2.5 Ah. Tests have shown that said capacity values are particularly well suited to use of powerful power tools in the construction industry and meet the requirements there for availability of electrical energy and possible periods of use of the power tool particularly well.

Preferably, the at least one cell of the energy supply device is configured to provide a discharge current of at least 20 A for at least 10 s. For example, a cell of the energy supply device may be configured to provide a discharge current of at least 20 A, in particular at least 25 A, for at least 10 s. In other words, the at least one cell of an energy supply device may be configured to provide a continuous current of at least 20 A, in particular at least 25 A.

Also, it is conceivable that peak currents, in particular short-term currents, may lead to severe heating of the energy supply device. Therefore an energy supply device with powerful cooling, as may be achieved with the measures described herein, is particularly advantageous. For example, it is conceivable that the at least one cell of the energy supply device can provide at least 50 A for more than 1 second. In other words, in the sense of the invention, it is preferred that the at least one cell of the energy supply device is configured to provide a discharge current of at least 50 A for at least 1 second. Power tools may often briefly require high power levels. An energy supply device with cells able to provide such a peak current and/or such a continuous current may therefore be particularly suitable for powerful power tools as are used on construction sites.

It is preferred in the context of the invention for the at least one cell to comprise an electrolyte, wherein the electrolyte is preferably present in a liquid state of aggregation at room temperature. The electrolyte can comprise lithium, sodium and/or magnesium, without be restricted thereto. In particular, the electrolyte can be lithium-based. As an alternative or in addition, said electrolyte can also be sodium-based. It is also conceivable for the rechargeable battery to be magnesium-based. The electrolyte-based energy supply device can have a rated voltage of at least 10 V, preferably at least 18 V, in particular of at least 28 V, for example 36 V. A rated voltage in a range of from 18 to 22 V, in particular in a range of from 21 to 22 V, is very particularly preferred. The at least one cell of the energy supply device can have, for example, a voltage of 3.6 V, without being restricted thereto.

In the sense of the invention, it is preferred that the energy supply device is charged for example with a charging rate of 1.5 C, preferably 2 C, and most preferably 3 C. A charging rate of xC means the current intensity which is required to fully charge a discharged energy supply device in a fraction of an hour corresponding to the digit x of the charging rate xC. A charging rate of 3 C for example allows full charging of the accumulator within 20 minutes.

It is preferred in the context of the invention for the at least one cell of the energy supply device to have a surface area A and a volume V, wherein a ratio A/V of surface area to volume is greater than six times, preferably eight times and particularly preferably ten times the inverse of the cube root of the volume.

The expression that the surface area A of the at least one cell is greater than eight times the cube root of the square of the volume V can preferably also be expressed by the formula A>8*V\hat{ }(2/3). Written another way, this relationship can be described in that the ratio A/V of surface area to volume is greater than eight times the inverse of the cube root of the volume.

For checking whether the above relationship is fulfilled, values in the same base unit must always be used. If for example a value for the surface area in m² is used in the above formula, preferably a value in the unit m³ is used for the volume. If for example a value for the surface area in the unit cm² is used in the above formula, preferably a value in the unit cm³ is used for the volume. If for example a value for the surface area in the unit mm² is used in the above formula, preferably a value in the unit mm³ is used for the volume.

Cell geometries which for example satisfy the relationship of A>8*V\hat{ }(2/3) advantageously have a particularly favorable ratio between the outer surface area of the cell, which is critical for the cooling effect, and the cell volume. The inventors have found that the ratio of the surface area to the volume of the at least one cell of the energy supply device has an important influence on the removal of heat from the energy supply device. The improved cooling capacity of the energy supply device can advantageously be achieved by increasing the cell surface area for a constant volume and a low internal resistance of the at least one cell. It is preferred in the context of the invention for a low cell temperature and a simultaneously high power output to preferably be possible when the internal resistance of the cell is reduced. The reduction in the internal resistance of the at least one cell can lead to the creation of less heat. Furthermore, a low cell temperature may be achieved owing to the use of cells in which the surface area A of at least one cell within the energy supply device is greater than six times, preferably eight times and particularly preferably ten times the cube root of the square of the volume V of the at least one cell. As a result, in particular the output of heat to the environment can be improved.

It has been found that energy storage devices with cells which satisfy said relationship can be better cooled than previously known energy supply devices with, for example, cylindrical cells. The above relationship can be satisfied, for example, in that although the cells of the energy supply device have a cylindrical basic shape, additional surface-increasing elements are arranged on its surface. Said elements can be, for example, fins, teeth or the like. Cells which do not have a cylindrical basic shape, but rather are shaped entirely differently, can also be used within the scope of the invention. For example, the cells of the energy supply device can have a substantially cuboidal or cube-like basic shape. The term “substantially” is not unclear to a person skilled in the art here because a person skilled in the art knows that, for example, a cuboid with indentations or rounded corners and/or edges should also be covered by the term “substantially cuboidal” in the context of the present invention.

It is preferred in the context of the invention for the at least one cell to have a cell core, wherein there is no point within the cell core that is more than 5 mm away from a surface of the energy supply device. When the energy supply device is discharged, for example when it is connected to a power tool and work is performed with the power tool, heat can be produced in the cell core. In this specific refinement of the invention, this heat can be transported on a comparatively short path as far as the surface of the cell of the energy supply device. The heat can be dissipated in an optimum manner from the surface. Therefore, such an energy supply device can exhibit good cooling, in particular comparatively good self-cooling. The time period until the limit temperature is reached can be extended and/or the situation of the temperature being reached can advantageously be entirely avoided. As a further advantage of the invention, a relatively homogeneous temperature distribution can be achieved within the cell core. This can result in uniform ageing of the rechargeable battery. This can in turn increase the service life of the energy supply device.

It is preferred in the context of the invention for the at least one cell to have a maximum constant current output of greater than 20 amperes, preferably greater than 30 amperes, most preferably greater than 40 amperes. The maximum constant current output is the quantity of current of a cell or an energy supply device that can be drawn without the cell or the energy supply device reaching an upper temperature limit. Possible upper temperature limits can lie in a region of 60° C. or 70° C., without being restricted thereto. The unit for the maximum constant current output is amperes.

All intermediate values should also always be considered to be disclosed in the case of all the value ranges that are mentioned in the context of the present invention. For example, values of between 20 and 30 A, that is to say 21, 22.3, 24, 25.55 or 27.06 amperes for example, should also be considered to be disclosed in the case of the maximum constant current output. Furthermore, values of between 30 and 40 A, that is to say 32, 33.3, 36, 38.55 or 39.07 amperes for example, should also be considered to be disclosed.

It is preferred in the context of the invention for the energy supply device to have a discharge C rate of greater than 80·t\hat{ }(−0.45), where the letter “t” stands for time in the unit seconds. The C rate advantageously allows quantification of the charging and discharge currents for energy supply devices, wherein the discharge C rate used here renders possible, in particular, the quantification of the discharge currents of energy supply devices. For example, the maximum permissible charging and discharge currents can be indicated by the C rate. These charging and discharge currents preferably depend on the rated capacity of the energy supply device. The unusually high discharge C rate of 80·t\hat{ }(−0.45) advantageously means that the energy supply device can be used to achieve particularly high discharge currents which are required for operating powerful power tools in the construction industry. For example, the discharge currents can lie in a region of greater than 40 amperes, preferably greater than 60 amperes or even more preferably greater than 80 amperes.

It is preferred within the meaning of the invention for the cell to have a cell temperature gradient of less than 10 Kelvin. The cell temperature is preferably a measure of the temperature differences within the at least one cell of the energy supply device, wherein it is preferred in the context of the invention for the cell to have a temperature distribution that is as uniform as possible, that is to say for a temperature in an inner region of the cell to differ as little as possible from a temperature which is measured in the region of a casing or outer surface of the cell.

### BRIEF DESCRIPTION OF THE DRAWINGS

Further advantages will become apparent from the following description of the figures. The figures, the description and the claims contain numerous features in combination. A person skilled in the art will expediently also consider the features individually and combine them to form useful further combinations.

Identical and similar components are denoted by the same reference signs in the figures.

In the drawing:

FIGS. 1a, 1b and 1c show possible embodiments of female contact partners with multiple individual contact points

FIG. 2 shows a preferred embodiment of the system of power tool and energy supply device

FIG. 3 shows a possible embodiment of the top side of an energy supply device of a preferred embodiment of the system

FIG. 4 shows a possible embodiment of a unit of female and male contact partners

FIG. 5 shows a further possible embodiment of a unit of female and male contact partners

FIGS. 6a, 6b and 6c are an illustration of a possible process of connecting an energy supply device and power tool

FIGS. 7a, 7b, 7c, 7d are an illustration of various combinations of spring-mountings and arrangements of the contact partners

FIGS. 8a, 8b, 8c, 8d are an illustration of various arrangements of the contact partners and their allocations

FIGS. 9a and 9b are an illustration of the individual spring-mounting of contacts in comparison with spring-mounting of a receiving device

FIG. 10 shows a schematic side view of a preferred embodiment of the energy supply device

FIG. 11 shows a schematic side view of a preferred embodiment of a current transmission pair with a first coating

FIG. 12 shows a schematic side view of a preferred embodiment of a current transmission pair with a lubricant

FIG. 13 shows a schematic side view of a preferred embodiment of a current transmission pair with a microstructure on the surface

FIG. 14 shows a schematic side view of a preferred embodiment of the system with two current transmission pairs

FIG. 15 shows a schematic side view of a preferred embodiment of the system with multiple current transmission pairs

FIG. 16 shows a schematic side view of a preferred embodiment of a current transmission pair with a first and a second coating

FIG. 17 shows a schematic view of a possible structure for resistance measurement

FIG. 18 shows a schematic side view of a possible structure for resistance measurement with multiple current transmission pairs.

### DETAILED DESCRIPTION OF THE FIGURES

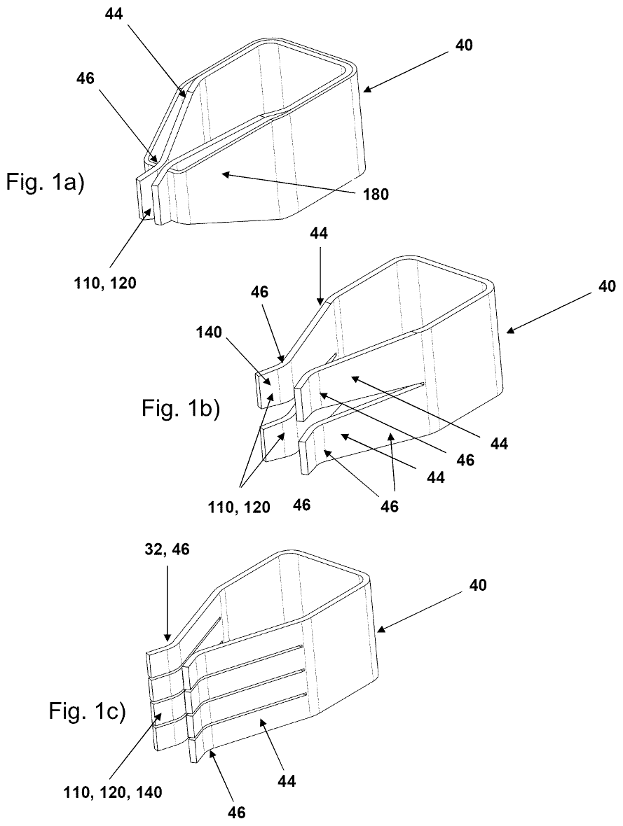

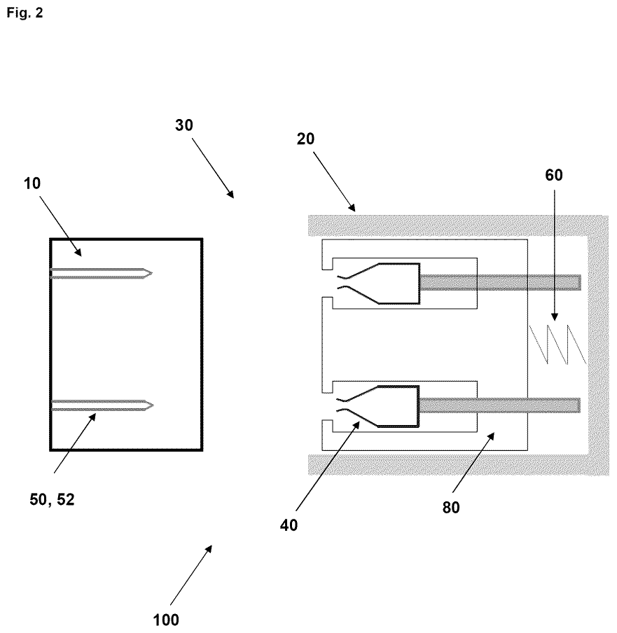

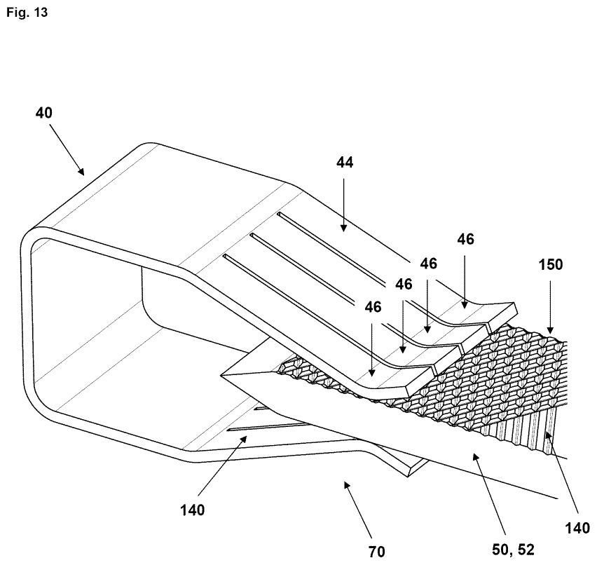

FIGS. 1a, 1b and 1c show possible embodiments of female contact partners 40 with multiple individual contact points 46. The part FIG. 1a shows a female contact partner 40 with an over-spring 180. The over-spring 180 may for example consist of or comprise spring steel, while the legs 44 of the female contact partner 40 comprise a material with good electrical conductivity, such as for example copper. The material of the contact arms 44 of the female contact partner 40 may preferably be designated also as base material 130. The contact arms 44 of the female contact partner 40 may be coated with at least one coating 110, 120, wherein for example in a first step, a second coating 120 with a high nickel proportion may be applied to the base material 130 of the female contact partner 40. This nickel subcoating thus serves to ensure that a first coating 110 applied in a second step holds or adheres better on the base material 130. The first coating 110 may preferably have a high silver proportion. The high silver proportion contributes to the good current conductivity of the legs 44 of the female contact partner 40. The first coating 110 is preferably applied on the insides of the contact arms 44 of the female contact partner 40 which, when connected, may be in contact with the male contact partners 50 of the interface 30. The insides of the legs 44 of the female contact partner 40, in the sense of the invention, are preferably also described as the top side 140 of the female contact partner 40. Preferably, the male contact partners 50 or their blades 52 also have a top side 140, which is shown for example in FIG. 13. The female contact partners 40 may preferably be present on the energy supply device 20 (see FIG. 2), while the male contact partners 50 may be present on the power tool 10 (see FIG. 2). The arrangement of contact partners 40, 50 with respect to the energy supply device 20 and power tool 10 may however also be reversed.

The over-spring 180 is configured to press the legs 44 of the female contact partners 40 onto the blades 52 (see FIG. 2) of the male contact partners 50 when the energy supply device 20 is connected to the power tool 10 (“when connected”). The contact partners 40, 50 then form an interface 30 with a contact region 32, wherein the contact region 32 of the interface may be formed by individual contact points 46. FIGS. 1a, 1b, 1c show several possibilities for increasing a number of individual contact points 46 in comparison with conventional interfaces as known from the prior art. The part FIG. 1a shows two individual contact points 46 in the region of the smallest distance between the contact arms 44 of the female contact partner 40, wherein the two individual contact points 46 preferably form touch points between the female contact partner 40 and a male contact partner 50 (see from FIG. 2) when the male contact partner 50 is inserted in the contact arms 44 of the female contact partner 40. In the part FIG. 1b, the female contact partner 40 has two contact arms 44 on each leg side, so that the number of individual contact points 46 is doubled in comparison with the exemplary embodiment of the invention shown in part FIG. 1a. In the exemplary embodiment of the invention shown in part FIG. 1b, the female contact partner 40 has four individual contact points 46. In the exemplary embodiment of the invention shown in part FIG. 1c, the female contact partner 40 has eight individual contact points 46. In part FIG. 1c, the contact arms 44 of the female contact partner 40 are further divided so that four contact arms 44 are present on each leg side. Thus the number of individual contact points 46 may be substantially increased in comparison with the exemplary embodiment of the invention shown in part FIG. 1a. In particular, local touch points, which are pressed onto the male contact partner 50 via an inherently sprung contact arm 44, constitute individual contact points 46. The individual contact points 46 may preferably be configured as points, lines or areas of touch. It is preferred in the sense of the invention that the individual contact points 46 are arranged in the contact regions 32 of the interface 30.

The female contact partner 40 shown in FIGS. 1a, 1b and 1c may have a microstructure 150 on its surface 140, wherein the microstructure 150 has a reduced peak height of more than 0.3 μm and/or a reduced groove depth of more than 0.3 μm. The microstructure 150 may be repeated preferably periodically on the surface 140 of the female contact partner 40 shown in FIGS. 1a, 1b and 1c. Preferably, the microstructure 150 may also be arranged on the surface 140 of the male contact partner 50. The female contact partner 40 shown in FIGS. 1a, 1b and 1c may have a lubricant 160 on its surface 140, wherein the lubricant 160 may have a grease proportion in percent by mass of more than 40%. Evidently, the male contact partner 50 or its surface 140 may also be greased with the lubricant 160.

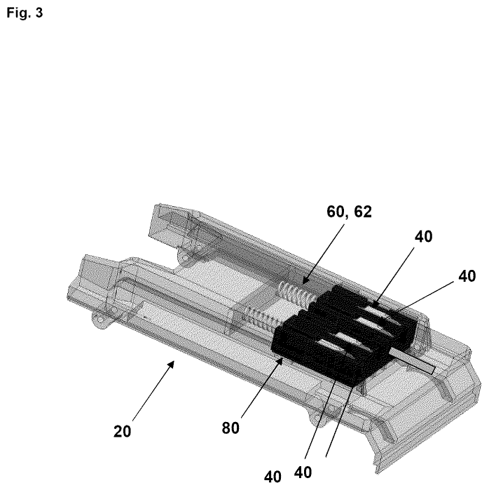

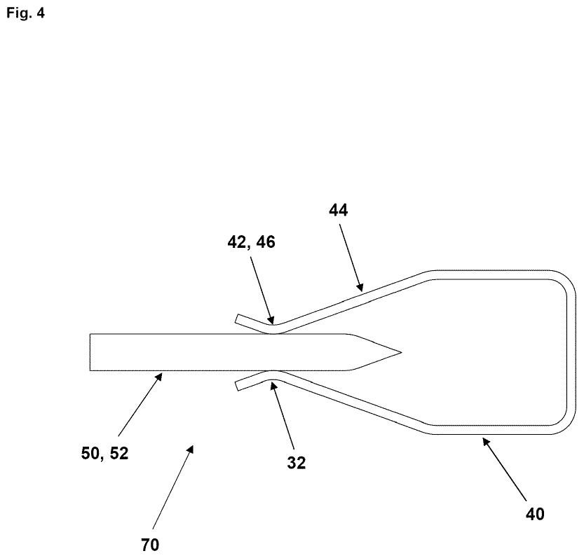

FIG. 2 shows a possible embodiment of the system 100 of power tool 10 and energy supply device 20. In the exemplary embodiment of the invention shown in FIG. 2, the power tool 10 is illustrated in the left image half and the energy supply device 20 in the right image half. The power tool 10 has two male contact partners 50, wherein in particular the blades 52 are shown in FIG. 2. The male contact partners 50 are part of an interface 30, wherein the interface 30 in addition also has female contact partners 40. In the exemplary embodiment of the invention illustrated in FIG. 2, the female contact partners 40 are arranged on the energy supply device 20. The female contact partners 40 may constitute individual contacts, or as illustrated in FIGS. 2 and 3, be integrated in a block or compartment. The block or compartment with the female contact partners 40 is described as the receiving device 80 (see FIG. 2). FIG. 2 shows in particular the case in which the power tool 10 and the energy supply device 20 are separate from one another. The power tool 10 and the energy supply device 20 may together form a system 100, wherein the energy supply device 20 is configured to supply the power tool 10 with electrical energy. In addition, the interface 30 comprises an elastic means 60 for reducing the relative distance between the male contact partners 50 and the female contact partners 40. The at least one elastic means 60 may comprise an elastic element 62 which may for example be a spring or a spiral spring. However, all other conceivable elastic elements 62 are possible and conceivable. When the male contact partners 50 are introduced into the female receiving terminals 40, the elastic means 60 for reducing the relative distance are compressed so that a particularly stable contact is created between the contact partners 40, 50. Such a contact is shown in FIG. 4. By contact of the contact partners 40, 50 and compression of the elastic means 60 for reducing a relative distance, a play or movement space results in which a unit 70 (see FIG. 4) of a male contact partner 50 and a female contact partner 40 may be present. A movement or vibration of the energy supply device 20 then leads to the unit 70 of male contact partner 50 and female contact partner 40 having sufficient play not to impact on the boundary walls of the movement space. Thus the energy supply device 20 is decoupled from the unit 70 of male contact partner 50 and female contact partner 40, whereby the unit 70 of male contact partner 50 and female contact partner 40 is particularly well protected. The stable contact between the contact partners 40, 50 means that particularly high currents can flow from the energy supply device 20 to the power tool 10. This is achieved in particular because the transition resistance between the contact partners 40, 50 can be substantially reduced with the invention, so that in particular also the temperatures measured in a contact region 32 (see FIG. 4) between the contact partners 40, 50 rise less greatly than in conventional interfaces as known from the prior art. Because of the reduced transition resistance and reduced temperatures in the contact region 32 of the interface 30, gratifyingly, the service life of the interface 30 is extended.

Although FIG. 2 shows that the male contact partners 50 are arranged on the power tool 10, and the female contact partners 40 on the energy supply device 20, a reversed arrangement may also be possible in which the male contact partners 50 are arranged on the energy supply device 20 and the female contact partners 40 on the power tool 10. In particular, in the sense of the invention, it may also be preferred that the male contact partners 50 are spring-mounted, i.e. are connected to an elastic means 60 for reducing a relative distance.

FIG. 3 shows a possible embodiment of the top side of an energy supply device 20 of a preferred embodiment of the system 100. The figure shows four female contact partners 40 which are arranged in a receiving device 80. In an exemplary embodiment of the invention, the receiving device 80 may also receive male contact partners 40, or male contact partners 40 and female contact partners 50. The receiving device 80 is in particular configured to receive the power or current contacts 40, 50 of the interface 30.

FIG. 4 shows a further possible embodiment of a unit 70 of a female contact partner 40 and a male contact partner 50. FIG. 4 in particular shows an interface 30 which has a female contact partner 40 and a male contact partner 50. In particular, FIG. 4 shows a connected state in which the energy supply device 20 and the power tool 10 are connected together so that current or electrical energy can flow from the energy supply device 20 towards the power tool 10. The blade 52 of the male contact partner 50 is arranged in the receiving terminal 44 or legs 44 of the female contact partner 40, wherein the contact partners 40, 50 together form a contact region 32 via which the current or electrical energy can be transmitted from the energy supply device 20 to the power tool 10. The contact region 32 is formed in particular in the region of a taper 42 of the female contact partner 40, in which the legs 44 or the components of the receiving terminal 44 of the female contact partner 40 adopt a minimum distance from one another. Thus the legs 44 of the female contact partner 40 lie particularly closely against the blade 52 of the male contact partner 50. FIG. 4 also shows a contact region 32 of the interface 30 which may coincide with the individual contact point 46.

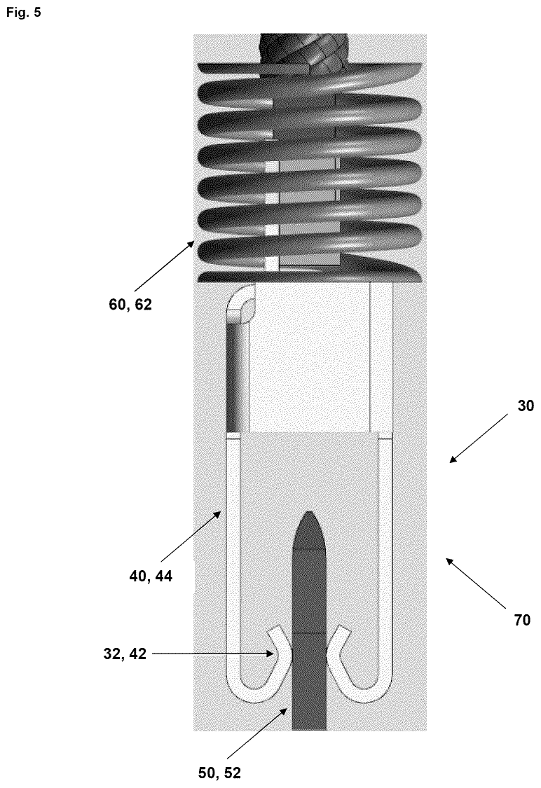

FIG. 5 shows a further possible embodiment of a unit 70 of a female contact partner 40 and a male contact partner 50. FIG. 5 shows in particular an interface 30 which has a female contact partner 40 and a male contact partner 50, and an elastic means 60 for reducing the relative distance between the contact partners 40, 50. The blade 52 of the male contact partner 50 is received by an interior of the female contact partner 40, wherein this interior is formed by the legs 44 of the female contact partner 40. The contact between the contact partners 40, 50 is present in particular in a contact region 32 of the interface 30 which, in the exemplary embodiment of the invention illustrated in FIG. 5, is arranged in the region of the smallest distance between the legs 44 of the female contact partner 40.

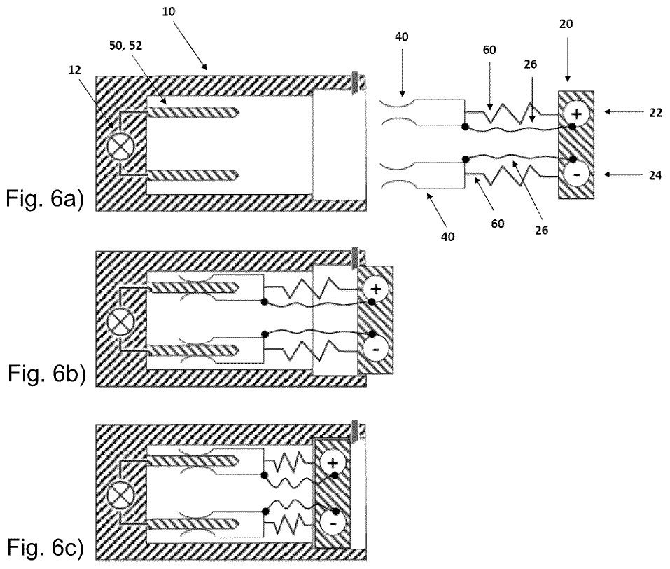

FIG. 6 is an illustration of a possible process of connecting an energy supply device 20 and power tool 10. FIG. 6 comprises three part figures a), b) and c), wherein part FIG. 6a) shows the energy supply device 20 and power tool 10 in a separated state, in which the energy supply device 20 and power tool 10 are separate from one another. Part FIG. 6b) shows the energy supply device 20 and power tool 10 at the moment in which the contact partners 40, 50 of the energy supply device 20 and power tool 10 are brought together or pressed onto one another, wherein the elastic spring-mounting means 60 is not yet elastically deformed in the state shown in FIG. 6b). This means that the elastic spring-mounting means 60 is not yet stressed in the state shown in FIG. 6b), so as yet there is no spring-mounting of the contact partners 40, 50. Part FIG. 6c) shows that the elastic spring-mounting means 60 are now compressed, i.e. stressed. This state preferably corresponds to the locked state in which the energy supply device 20 and power tool 10 are connected together, and in which the energy supply device 20 can supply the power tool 10 with electrical energy.

The energy supply device 20 has a positive pole 22 and a negative pole 24, wherein a respective pole 22, 24 may be connected via a respective current conductor 26 to a contact partner, here a female contact partner 50. The current conductors 26 may preferably form an elastic current connection 26 between the spring-mounted female contact partners 40 in FIG. 6 and the energy supply device 20. An elastic current conductor 26 is advantageously particularly suited for supporting the movability of the contact partners 40, 50, so that an optimum decoupling of the contact partners 40, 50 can be guaranteed. In the sense of the invention, it may be preferred that the preferably elastic current conductor 26 comprises or is formed by a braided wire. Preferably, the preferably elastic current conductor 26 comprises several individual wires which may preferably be twisted together. For example, in the sense of the invention, it may be preferred that the preferably elastic current conductor 26 comprises more than ten individual wires. The elastic spring-mounting means 60 preferably connects the contact partners, here the female contact partners 50, to the energy supply device 20. The power tool 10 may have a consumer 12 which may for example be the motor 12 of the power tool 10. The reference signs in FIG. 6 are only given for the part FIG. 6a) but apply accordingly to the part FIGS. 6b) and 6c).

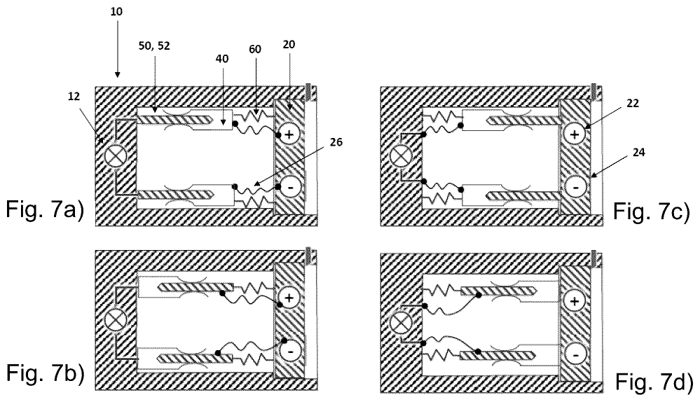

FIGS. 7a, 7b, 7c, 7d show various combinations of spring-mountings and arrangements of the contact partners 40, 50. The exemplary embodiment of the invention shown in part FIG. 7a has two male contact partners 50 with their blades 52 arranged on the power tool 10. The power tool 10 may comprise a consumer 12, for example a motor. The part figures of FIGS. 7a, 7b, 7c and 7d show the power tool 10 and the energy supply device 20 in a connected state. In the exemplary embodiment of the invention shown in part FIG. 7b, the female contact partners 50 are present on the energy supply device 20, wherein the energy supply device 20 illustrated has in particular two female contact partners 50. In the exemplary embodiment of the invention shown in part FIG. 7b, the number of female contact partners 50 thus corresponds to the number of male contact partners 40. In this context, this preferably means that the power tool 10 and the energy supply device 20 have the same number of contact partners 40, 50, wherein the power tool 10 shown in part FIG. 7a has two male contact partners 50 and the energy supply device 20 shown in part FIG. 7a has two female contact partners 40. The energy supply device 20 has two poles 22, 24, namely a positive pole 22 and a negative pole 24. The poles 22, 24 of the energy supply device 20 are each connected to the contact partners 40 via a respective, preferably elastic current conductor 26, wherein the contact partners of the energy supply device 20 in part FIGS. 7a and 7d are female contact partners 40. In the exemplary embodiment of the invention shown in part FIG. 7a, the spring-mounting is present in the region, i.e. on the side, of the energy supply device 20. In the exemplary embodiments of the invention shown in part FIGS. 7a and 7d, the male contact partners 50 are each connected to the power tool 10 while the female contact partners 40 are connected to the energy supply device 20. The reference signs are only given for the part FIG. 7a but apply accordingly to the other part FIGS. 7ab, 7c, 7d.

Part FIG. 7b shows an exemplary embodiment of the invention in which the power tool 10 has female contact partners 40, and the energy supply device 20 has male contact partners 50. Here too, both the power tool 10 and the energy supply device 20 have two contact partners 40, 50. In the exemplary embodiment of the invention shown in part FIG. 7b, the blades 52 of the male contact partners 50 are each connected to the energy supply device 20 via an elastic spring-mounting means 60, while the blades are also electrically connected to a respective pole 22, 24 of the energy supply device 20 via a current conductor 26. In the exemplary embodiment of the invention shown in part FIG. 7b, the spring-mounting is also present in the region, i.e. on the side, of the energy supply device 20.

In the exemplary embodiment of the invention shown in part FIGS. 7c and 7d, the spring-mounting is present in the region, i.e. on the side, of the power tool 10. Part FIG. 7c also shows an exemplary embodiment of the invention in which the power tool 10 has female contact partners 40, and the energy supply device 20 has male contact partners 50. The female contact partners 40 are connected conductively to the power tool 10 via a current conductor 26, wherein the electrical connection exists in particular between the female contact partners 40 and the consumer 12 of the power tool 10. The female contact partners 40 are also connected to the power tool 10 via elastic spring-mounting means 60. In the region of the energy supply device 20, the male contact partners 50, in particular their blades 52, are each connected to a pole 22, 24 of the energy supply device 20. The energy supply device 20 has two male contact partners 50, wherein precisely one male contact partner 50 may be assigned to each pole 22, 24 of the energy supply device 20.

Part FIG. 7d also shows an exemplary embodiment of the invention in which the power tool 10 has male contact partners 50, and the energy supply device 20 has female contact partners 40. The spring-mounting, i.e. the elastic spring-mounting means 60, lies in the region of the power tool 10 in the exemplary embodiment of the invention shown in part FIG. 7d. The power tool 10 is connected to a respective male contact partner 50 or its blade 52 via an elastic spring-mounting means 60. In addition, in the exemplary embodiment of the invention shown in part FIG. 7d, a current-conductive connection exists between the consumer 12 of the power tool 10 and the male contact partners 50. The current-conductive connection between the consumer 12 of the power tool 10 and the male contact partners 50 may in particular be achieved by a current conductor 26. In the exemplary embodiment of the invention shown in part FIG. 7d, the energy supply device 20 has two female contact partners 40, wherein each female contact partner 40 of the energy supply device 20 may be assigned to a respective one of the two poles 22, 24 of the energy supply device 20.

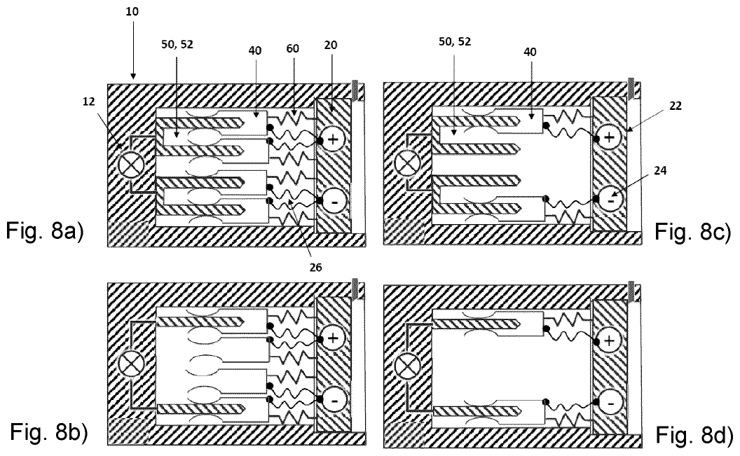

FIGS. 8a, 8b, 8c, 8d show various arrangements of the contact partners 40, 50 and their allocations. FIG. 8a shows a power tool 10 with four male contact partners 50 and an energy supply device 20 with four female contact partners 40. The male contact partners 50 of the power tool 10 are conductively connected to a consumer 12 of the power tool 10, in order to supply this with electrical energy which the power tool 10 receives from the energy supply device 20. The female contact partners 40 of the energy supply device 20 are each connected by a respective conductor to a pole 22, 24 of the energy supply device 20, wherein in the exemplary embodiment of the invention shown in part FIG. 8a, two female contact partners 40 are connected to the positive pole 22 of the energy supply device 20, and two other female contact partners 40 are connected to negative pole 24 of the energy supply device 20. In addition, the female contact partners 40 are connected to the energy supply device 20 via an elastic spring-mounting means 60. The spring-mounting in all part figures of FIGS. 8a, 8b, 8c, 8d takes place on the side of the energy supply device 20. In addition, a common feature of all part figures of FIGS. 8a, 8b, 8c, 8d is that the male contact partners 50 are present on the power tool 10, while the female contact partners 40 are arranged on the energy supply device 20. The part figures of FIGS. 8a, 8b, 8c, 8d however differ in the number of respective contact partners 40, 50, and the number of current transmission pairs which can be formed in each case. In the exemplary embodiment of the invention shown in part FIG. 8a, for example four current transmission pairs are shown, each comprising a female contact partner 40 and a male contact partner 50. With four current transmission pairs, a potential of the energy supply device 20 can be particularly well used, and a large quantity of electrical energy can be transmitted from the energy supply device 20 to the power tool 10. For example, currents of more than 50 A, preferably more than 70 A and most preferably more than 100 A can be transmitted with such an interface 30. The currents are preferably constant currents. The reference signs in FIG. 8 are only given for the part FIG. 8a but apply accordingly to the other part FIGS. 8b, 8c, 8d.

In the exemplary embodiment of the invention shown in part FIG. 8b, for example two current transmission pairs are formed, each comprising a female contact partner 40 and a male contact partner 50, while two female contact partners 40 of the energy supply device 20 are not occupied, i.e. are unused or empty. In the exemplary embodiment of the invention shown in part FIG. 8b, because of the lower number of current transmission pairs, less current can be transmitted from the energy supply device 20 to the power tool 10 than in the exemplary embodiment of the invention shown in part FIG. 8a, in which the interface 30 comprises four current transmission pairs. In the exemplary embodiment of the invention shown in part FIG. 8b, the energy supply device 20 has four female contact partners 40, but the power tool 10 only has two male contact partners 50.

In the exemplary embodiment of the invention shown in part FIG. 8c, again two current transmission pairs are formed, each comprising a female contact partner 40 and a male contact partner 50, while two male contact partners 50 of the energy supply device 10 are not connected to a female contact partner 40. In the exemplary embodiment of the invention shown in part FIG. 8c, because of the lower number of current transmission pairs, less current can be transmitted from the energy supply device 20 the power tool 10 than in the exemplary embodiment of the invention shown in part FIG. 8a, in which the interface 30 comprises four current transmission pairs. In the exemplary embodiment of the invention shown in part FIG. 8c, the energy supply device 10 has four male contact partners 50, but the power tool 20 only has two female contact partners 40.

In the exemplary embodiment of the invention shown in part FIG. 8d), the power tool 10 has two male contact partners 50, and the energy supply device 20 has two female contact partners 40. Thus in the exemplary embodiment of the invention illustrated, for example two current transmission pairs may be formed, and the amount of energy to be transmitted or the size of the currents which can be transmitted corresponds to the exemplary embodiments of the invention shown in part FIGS. 8b) and 8c).

In the exemplary embodiment of the invention shown in FIGS. 6 to 8, in each case an individual spring-mounting is shown, i.e. each contact partner 40, 50 has an elastic spring-mounting means 60 on the side of the connection partner of the interface 30 at which the spring-mounting takes place. This means that the contact partners 40, 50 are individually spring-mounted.

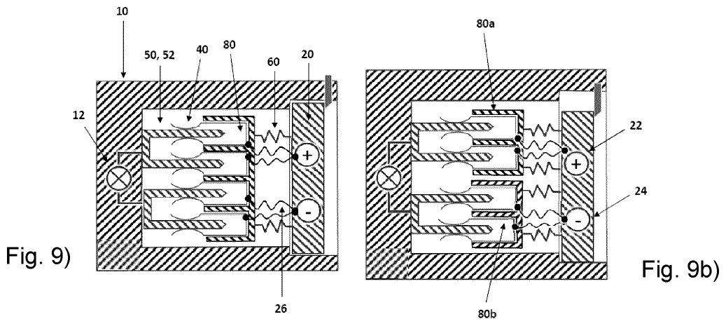

FIGS. 9a and 9b show receiving devices 80 which, in the exemplary embodiment of the invention shown in part FIG. 9a, comprise the four female contact partners 40 of the energy supply device 20. In the known fashion, the female contact partners 40 are actively connected to the blades 52 of the male contact partners 50 so that current transmission pairs are formed, wherein in the exemplary embodiment of the invention shown in part FIG. 9a, four current transmission pairs 70 are formed. The receiving device 80 shown in part FIG. 9a is part of the energy supply device 20 and is connected to the poles 22, 24 of the energy supply device 20 via four current conductors 26, and mechanically connected to the energy supply device 20 via two spring-mounting means 60. The receiving device 80 preferably forms a contact block which can be spring-mounted as a block with a specific number of elastic spring-mounting means 60.

In the exemplary embodiment of the invention shown in part FIG. 9b, two receiving devices 80 are shown, wherein two female contact partners 40 are present in each receiving device 80. Each of the two receiving devices 80 is connected to the energy supply device 20 via two elastic spring-mounting means 60, and to the poles 22, 24 of the energy supply device 20 via two current conductors 26. Here, in each case two current conductors 26 provide a connection between the positive pole 22 of the energy supply device 20 and the first receiving device 80a, while two other current conductors 26 provide the connection between the negative pole 24 of the energy supply device 20 and the second receiving device 80b. The reference signs are only given for FIG. 9a but apply accordingly to the other parts of FIG. 9b.

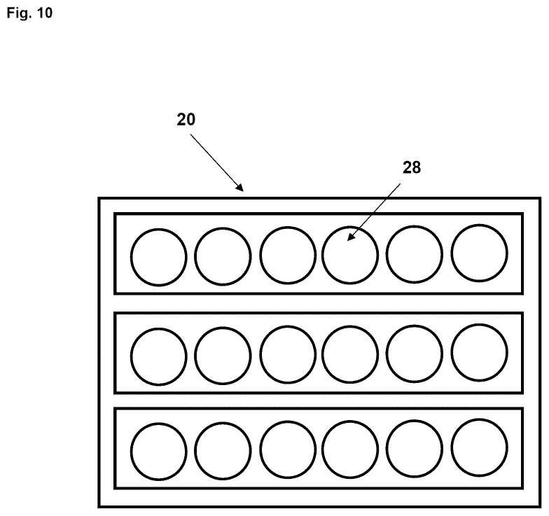

FIG. 10 shows a schematic side view of a preferred configuration of the energy supply device 20. The energy supply device 20 shown in FIG. 10 has eighteen cells 28, wherein the eighteen cells 28 are arranged in three rows within the energy supply device 20. The cells 28 are in particular symbolized by circles, while the rows are symbolized by the linear rectangles which surround the circles (“cells 28”).

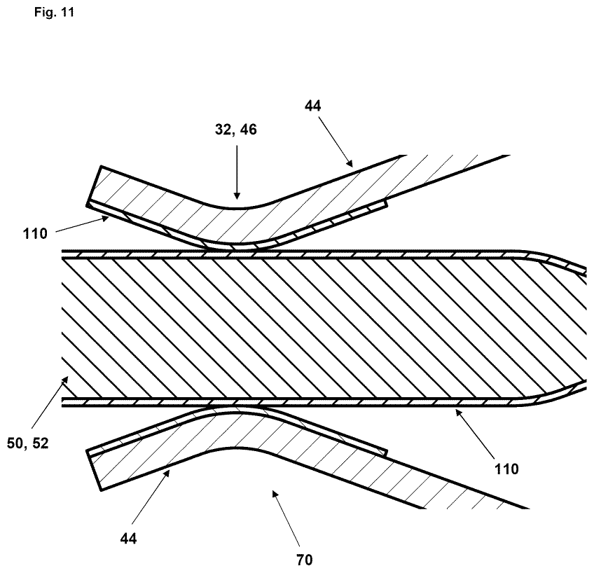

FIG. 11 shows a schematic side view of a preferred embodiment of a current transmission pair 70 with a first coating 110. The current transmission pair 70 preferably comprises a male contact partner 50 with a blade 52, and a female contact partner 40 with at least one contact arm 44. The first coating 110 is present preferably on both a surface 140 of the male contact partner 50 and also on a surface 140 of the female contact partner 40. The surface 140 of the female contact partner 40 may preferably be formed by insides of the contact arms 44 of the female contact partner 40. The first coating 110 and also the second coating 120 (not shown in FIG. 11) are preferably present in the region of the contact region 32 of the interface 30, wherein the individual contact points 46 of the contact partners 40, 50 are also preferably present in this contact region 32 of the interface 30.

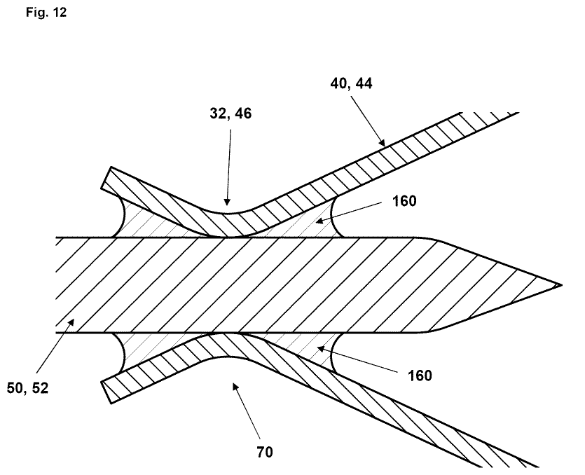

FIG. 12 shows a schematic side view of a preferred embodiment of a current transmission pair 70 with a lubricant 160. The current transmission pair 70 preferably comprises a male contact partner 50 with a blade 52, and a female contact partner 40 with at least one contact arm 44. The lubricant 160 is preferably also present in the contact region 32 of the interface 30, wherein preferably the individual contact points 46 of the contact partners 40, 50 are also arranged there.

FIG. 13 shows a schematic side view of a preferred embodiment of a current transmission pair 70 with a microstructure 150. The current transmission pair 70 preferably comprises a male contact partner 50 with a blade 52, and a female contact partner 40 with at least one contact arm 44. In FIG. 13, the four individual contact points carry reference sign 46. These four individual contact points 46 are formed by the upper of the two contact arms 44 of the female contact partner 40. Since the female contact partner 40 has two contact arms 44, four further individual contact points 46 (not shown) are also present below the blade 52 of the male contact partner 50. In total, the current transmission pair 70 shown in FIG. 13 comprises eight individual contact points 46. The preferred embodiment of the microstructure 150 shown in FIG. 13 is preferably present on a top side 140 of the male contact partner 50 or on a top side 140 of its blade 52. However, in the sense of the invention, it may also be preferred that the microstructure 150 is present on a top side 140 of the female contact partner 40, in particular on the insides of the legs 44 of the female contact partner 40. As FIG. 13 shows, the illustrated microstructure 150 is configured to be periodically recurrent, i.e. the microstructure 150 has periodically recurrent patterns and structures which preferably form the microstructure 150.

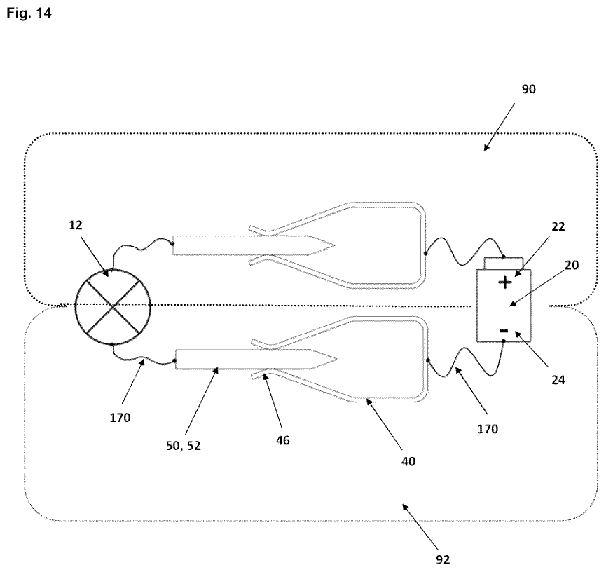

FIG. 14 shows an exemplary embodiment of the invention, in particular a system 100, which comprises a power tool 10 and an energy supply device 20. In particular, an exemplary embodiment of the invention is shown in which each pole 22, 24 of the energy supply device 20 is connected to a respective current transmission pair 70. In the exemplary embodiment of the invention shown in FIG. 14, the poles 22, 24 of the energy supply device 20 are each connected via a current conductor 26 or braid 170 to a respective female contact partner 40, wherein this female contact partner 40 may be connected to a male contact partner 50 so as to form a current transmission pair 70. In the exemplary embodiment of the invention shown in FIG. 14, the female contact partners 40 have two legs 44 or contact arms 44, wherein the legs 44 or contact arms 44 of the female contact partner 40 lie one on each side of the blade 52 of the male contact partner 50 when connected. In this way, preferably two individual contact points 46 are formed, namely one on each side of the blade 52, or an individual contact point 46 per leg 44 or contact arm 44.

In the exemplary embodiment of the invention shown in FIG. 14, current or electrical energy can flow along two current paths 90, 92. A first current path 90 preferably extends from the positive pole 22 of the energy supply device 20 in the direction of the power tool 10, in particular in the direction of the consumer 12 of the power tool 10. In other words, the first current path 90 is configured to connect the cathode 22 of the energy supply device 20 to the consumer 12 of the power tool 10. A second current path 92 preferably extends from the power tool 10, in particular the consumer 12 of the power tool 10, in the direction of the energy supply device 20, in particular in the direction of the negative pole 24 of the energy supply device 20. In other words, the second current path 92 is configured to connect the consumer 12 of the power tool 10 to the anode 24 of the energy supply device 20. The electrical energy or current is preferably transmitted via the current transmission pairs 70, wherein in the exemplary embodiment of the invention shown in FIG. 14, each pole 22, 24 of the energy supply device 20 is connected to a respective current transmission pair 70. Thus each of the two current paths 90, 92 comprises precisely one current transmission pair 70 in the interface 30 between the power tool 10 and the energy supply device 20.

The current transmission pair 70 comprises a male contact partner 50 with a blade 52 and a female contact partner 40 with contact arms 44 or legs 44, wherein the contact arms 44 or legs 44 of the female contact partner 40 are in contact with the blade 52 of the male contact partner at the individual contact point 46. The contact partners 40, 50 may be connected to the energy supply device 20 or the power tool 10 via connecting lines 170.

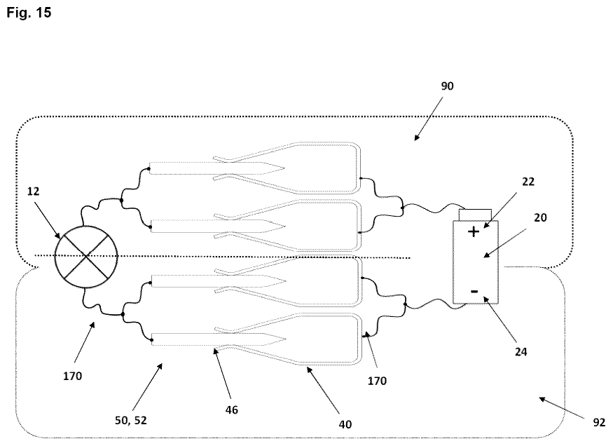

FIG. 15 shows an exemplary embodiment of the invention, in particular a system 100, which comprises a power tool 10 and an energy supply device 20, wherein more than one current transmission pair 70 may be assigned to the poles 22, 24 of the energy supply device 20. In the exemplary embodiment of the invention shown in FIG. 15, for example in each case two female contact partners 40 or two current transmission pairs 70 may be assigned to both poles 22, 24 of the energy supply device 20.

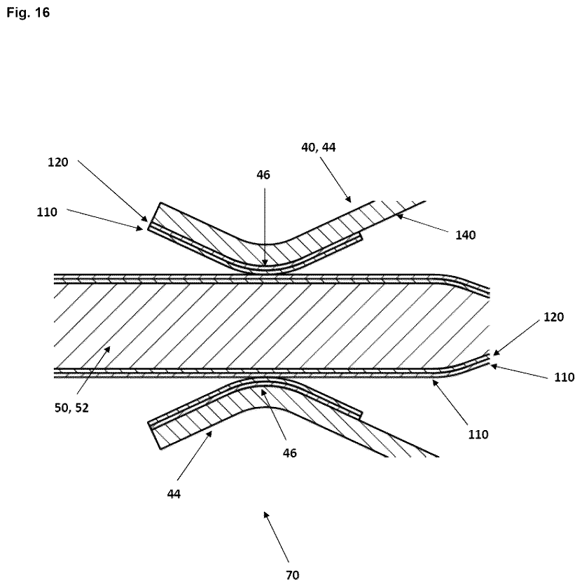

FIG. 16 shows a schematic side view of a preferred embodiment of a current transmission pair 70 with a first coating 110 and a second coating 120. The current transmission pair 70 preferably comprises a male contact partner 50 with a blade 52, and a female contact partner 40 with at least one contact arm 44. The coatings 110, 120 are present preferably both on a surface 140 of the male contact partner 50 and also on a surface 140 of the female contact partner 40. The surface 140 of the female contact partner 40 may preferably be formed by insides of the contact arms 44 of the female contact partner 40. In the exemplary embodiment of the invention shown in FIG. 16, the contact partners 40, 50 touch one another with the first coating 110, wherein the first coating 110 preferably constitutes an outer coating of the contact partners 40, 50. The second coating 120 is preferably present between surfaces 140 of the male contact partner 50 and of the female contact partner 40, and preferably serves to improve the adhesion of the first coating 110 on the surface 140 of the contact partners 40, 50.

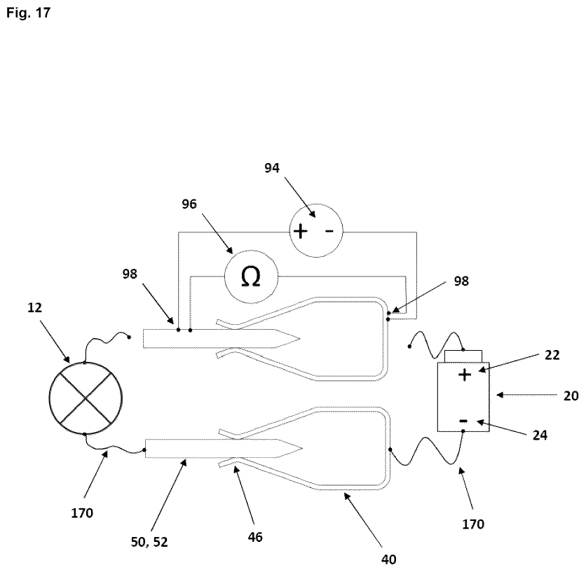

FIG. 17 shows a possible structure for measuring a contact resistance of an individual current transmission pair 70. Here, the two connecting lines 170 of the contact partners 40, 50 to the energy supply device 20 and power tool 10 may be separated, so that only the electrical resistance of the female contact partner 40 and male contact partner 50 in connected state is measured. In other words, a total may be formed of the resistance of the female contact partner 40 and of the male contact partner 50, and is designated the contact resistance of the current transmission pair 70.

FIG. 17 also shows the points of the current transmission pair 70 at which measurement lines to the contact partners 40, 50 may be arranged, in order to carry out a resistance measurement and in this way determine the total electrical transition resistance of the interface 30 for each pole 22, 24. The corresponding points on the contact partners 40, 50 at which the measurement lines may be attached are preferably designated the “current take-off points 98”. Measurement of the total electrical resistance of the interface 30 in the context of the present invention preferably refers in each case to one pole 22, 24 of the energy supply device 20, being either the positive pole 22 or the negative pole 24. In other words, the resistance of the current transmission pairs 70 may be measured in the first current path 90 between the cathode 22 of the energy supply device 20 and the power tool 10, or in the second current path 92 between the power tool 10 and the anode 24 of the energy supply device 20.

The resistance measurement may preferably comprise a four-conductor measurement process, well known to the person skilled in the art. The measurement is preferably carried out at room temperature in a temperature range from 19 to 23° C., particularly preferably at a room temperature of 21° C. For example, an arithmetic mean of e.g. ten individual measurements may be used for determining the total electrical transition resistance. Preferably, the contact partners 40, 50 may be connected together ten times before starting the measurement and once after each individual measurement. In the sense of the invention, it is preferred that the measurement lines which are connected to a measurement current supply device 94, and the measurement lines which are connected to an ohmmeter 96 and used for resistance measurement, are conducted to the measurement point separately from one another. In the sense of the invention, it is preferred that the measurement current supply device 94 provides a current of 1 ampere (A). In the sense of the invention, this preferably means that the measurement lines which are connected to a measurement current supply device 94 are loaded with a measurement current of 1 A.

The current take-off points 98, between which resistance is measured, are arranged on the contact partners 40, 50 of the current transmission pair 70, preferably in the close physical vicinity of the at least one individual contact point 46 at which the contact partners 40, 50 are in contact with one another. If the poles 22, 24 of the energy supply device 20 are each connected to a contact partner 40, 50, the total transition resistance of an individual contact partner 40, 50 corresponds to the total transition resistance of the current transmission pair 70 or interface 30.

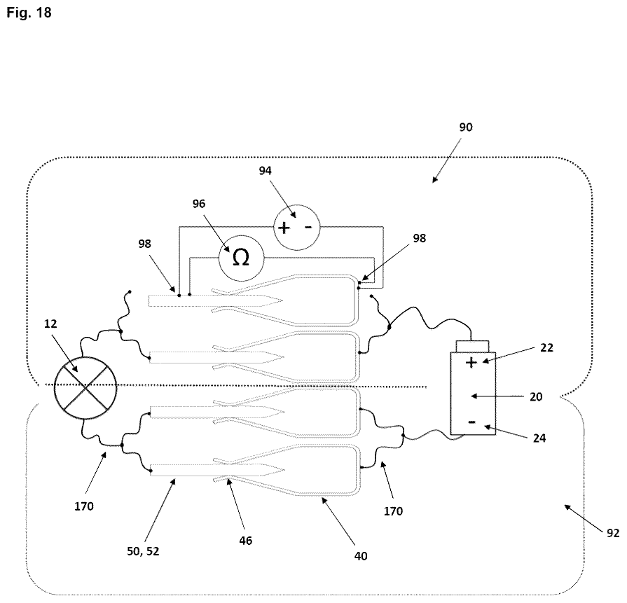

FIG. 18 shows the structure for measuring a total transition resistance in the case of several contact partners 40, 50 per pole 22, 24. It is preferred in the context of the invention to measure the contact resistances R1, R2, . . . . Rn of the current transmission pairs 70, wherein each current transmission pair 70 preferably comprises or consists of one female contact partner 40 and one male contact partner 50. The total electrical transition resistance of the interface 30 per pole 22, 24 is calculated using the following formula

$${R}_{g e s} = 1 / ( 1 / {R}_{1} + 1 / {R}_{2} + … 1 / {R}_{n} ) ,$$

which describes the calculation of a total resistance from the sum of the preferably parallel-connected individual resistances. The index “n” preferably stands for the number of contact partners 40, 50 per pole 22, 24. In the exemplary embodiment of the invention shown in FIG. 18, n=2. In the exemplary embodiment of the invention shown in FIG. 15, the measurement of the total electrical transition resistance is carried out in the upper, i.e. the first current path 90, wherein the first current path 90 connects the positive pole 22 of the energy supply device 20 to the power tool 10. In the sense of the invention, it may equally well be preferred that the measurement of the total electrical transition resistance is carried out in the lower, i.e. the second current path 92, wherein the second current path 92 connects the power tool 10 to the negative pole 24 of the energy supply device 20.

During performance of the resistance measurements, it is preferred that the braids or measurement lines are soldered or welded in place. The resistance measurements are in particular carried out without additional connecting means such as clamps or similar.

### LIST OF REFERENCE SIGNS

10 Power tool
12 Consumer in the power tool, e.g. motor
20 Energy supply device
22 Positive pole of energy supply device
24 Negative pole of energy supply device
26 Current conductor
28 Energy storage cell
30 Interface
32 Contact region
40 Female contact partner
42 Taper
44 Leg of female contact partner
46 Individual contact point
50 Male contact partner
52 Blade
60 Means for reducing a relative movement
62 Elastic element
70 Unit of female and male contact partners, power transmission pair
80 Receiving device
90 First current path
92 Second current path
94 Measurement current supply device
96 Resistance meter
98 Current take-off points
100 System
110 First coating
120 Second coating
130 Base material
140 Surface
150 Microstructure
160 Lubricant
170 Braid
180 Over-spring

1-15. (canceled)

16. A system comprising:
a power tool; and
an energy supply for supplying the power tool with electrical energy, the energy supply releasably connectable to the power tool via an interface,
the interface including at least a female contact partner and a male contact partner, the interface having a total electrical transition resistance per pole of less than 0.4 milliohm, at least one of the female and male contact partners having a first coating with a graphite proportion of less than 30%.

17. The system as recited in claim 16 wherein the total electrical transition resistance per pole is less than 0.3 milliohm.

18. The system as recited in claim 17 wherein the total electrical transition resistance per pole is less than 0.2 milliohm.

19. The system as recited in claim 16 wherein the interface has at least six individual contact points per pole.

20. The system as recited in claim 19 wherein the interface has at least eight individual contact points per pole.

21. The system as recited in claim 21 wherein the interface has at least twelve individual contact points per pole.

22. The system as recited in claim 16 wherein at least one of the contact partners has a first coating wherein a silver proportion of the first coating in percent by mass lies in a region of more than 70%.

23. The system as recited in claim 22 wherein the silver proportion of the first coating in percent by mass lies a region of more than 95%.

24. The system as recited in claim 22 wherein at least one of the contact partners has a second coating, wherein a nickel proportion of the second coating in percent by mass lies in a region of more than 83%.

25. The system as recited in claim 24 wherein the second coating is configured to improve an adhesion of the first coating to a base material of the contact partner.

26. The system as recited in claim 24 wherein a total thickness of the first coating and the second coating lies in a region of more than 4 μm.

27. The system as recited in claim 26 wherein a total thickness of the first coating and the second coating lies in a region of more than 8 μm.

28. The system as recited in claim 27 wherein a total thickness of the first coating and the second coating lies in a region of more than 10 μm.

29. The system as recited in claim 16 wherein at least one of the male and female contact partners has a microstructure on a surface, the microstructure having a reduced peak height of more than 0.3 μm or a reduced groove depth of more than 0.3 μm.

30. The system as recited in claim 29 wherein the microstructure is repeated periodically on the surface of the at least one of the male and female contact partners.

31. The system as recited in claim 16 wherein at least one of the male and female contact partners has a lubricant on a surface, wherein the lubricant having an oil proportion in percent by mass of more than 40%.

32. The system as recited in claim 31 wherein the lubricant contains at least one solid for thickening, wherein the solid includes a metal soap or a polyurea.

33. The system as recited in claim 31 wherein the lubricant includes at least one additive for wear protection or for deactivation of non-ferrous metals.

34. The system as recited in claim 16 wherein the interface has at least one elastic current conductor.

35. The system as recited in claim 16 wherein at least one of the male and female contact partners of the interface are connectable together releasably via a plug connection.

36. An energy supply device for use in the system as recited in claim 16 wherein the energy supply device has at least one energy storage cell, wherein the at least one energy storage cell has an internal resistance DCR_I of less than 10 milliohm.

37. An energy supply device for use in the system as recited in claim 16 wherein the energy supply device has at least one energy storage cell, wherein the at least one energy storage cell has a surface area A and a volume V, wherein a ratio A/V of the surface area to the volume is greater than six times the inverse of the cube root of the volume.

38. The energy supply device as recited in claim 37 wherein the ration A/V is greater than eight times the inverse of the cube root of the volume.

39. The energy supply device as recited in claim 37 wherein the ration A/V is greater than ten times the inverse of the cube root of the volume.
